(19) United States
(12) Patent Application Publication
(10) Pub. No.: US 2011/0154165 A1
(43) Pub. Date: Jun. 23, 2011

(54) STORAGE APPARATUS AND DATA TRANSFER METHOD

(76) Inventors: Zaki Primadani, Fujisawa (JP); Xiaoming Jiang, Odawara (JP); Susumu Tsuruta, Odawara (JP)

(21) Appl. No.: 12/527,176

(22) PCT Filed: Jun. 4, 2009
(86) PCT No.: PCT/JP2009/057538

§ 371 Date: Aug. 13, 2009

(51) Int. Cl. G06F 11/10

(52) U.S. Cl. 714/799; 714/E11.034

(57) ABSTRACT

A storage apparatus includes: a host control unit for sending/receiving data to/from a host server; a drive control unit for sending/receiving the data to/from a storage device; a cache memory for temporarily storing the data sent and received between the host control unit and the drive control unit; a switch for switching between a transfer source and a transfer destination when transferring the data by selecting the transfer source and the transfer destination from among the host control unit, the cache memory, and the drive control unit; and a controller for controlling the host control unit, the drive control unit, and the switch; wherein processing for generating an error check code for the data and error check processing using the error check code are executed by the switch or are distributed among and executed by the host control unit, the drive control unit, the switch, and the controller.

### TECHNICAL FIELD

The present invention relates to a storage apparatus and a data transfer method and is ideal for use in a storage apparatus for transferring data in the storage apparatus by adding an error check code to write data sent from a host server.

### BACKGROUND ART

Conventionally, this type of storage apparatus is designed to add an error check code such as LA/LRC to write data from a host server and check correctness of the write data using this error check code so that highly-reliable data transfer can be performed in the storage apparatus.

Therefore, a dedicated data control LSI (Large Scale Integration) having an error check function adding the above-described error check code to write data and checking errors in the relevant data using this error check code is mounted on the above-described type of storage system, and this data control LSI performs the error check code addition processing and the error check processing using the error check code.

Recently, providing dual controllers in a storage apparatus has also been suggested in terms of enhancement of fault tolerance (see, for example, Japanese Patent Application Laid-Open (Kokai) Publication No. 2008-097527).

### DISCLOSURE OF THE INVENTION

In recent years, prices of storage apparatuses have been reduced. Under such circumstances, there is a problem of high manufacturing costs because the data control LSI is a special order item. This problem is serious for a storage apparatus having dual controllers as mentioned above. Therefore, there is a need for a data transfer technique capable of highly-reliable data transfer in a storage apparatus using a general-purpose switch instead of the above-described data control LSI.

The present invention was devised in light of the circumstances described above. It is an object of this invention to provide a storage apparatus and data transfer method capable of highly-reliable data transfer, while keeping costs low.

In order to achieve the above-described object, a storage apparatus according to the present invention for reading/writing data from/to a storage area provided by a storage device in response to a request from a host server is characterized in that the storage apparatus includes: a host control unit for sending/receiving the data to/from the host server; a drive control unit for sending/receiving the data to/from the storage device; a cache memory for temporarily storing the data sent and received between the host control unit and the drive control unit; a switch for switching between a transfer source and a transfer destination when transferring the data by selecting the transfer source and the transfer destination from among the host control unit, the cache memory, and the drive control unit; and a controller for controlling the host control unit, the drive control unit, and the switch; wherein processing for generating an error check code for the data and error check processing using the error check code are executed by the switch or are distributed among and executed by the host control unit, the drive control unit, the switch, and the controller.

A method for transferring data according to the present invention in a storage apparatus for reading/writing data from/to a storage area provided by a storage device in response to a request from a host server is characterized in that the storage apparatus includes: a host control unit for sending/receiving the data to/from the host server; a drive control unit for sending/receiving the data to/from the storage device; a cache memory for temporarily storing the data sent and received between the host control unit and the drive control unit; a switch for switching between a transfer source and a transfer destination when transferring the data by selecting the transfer source and the transfer destination from among the host control unit, the cache memory, and the drive control unit; and a controller for controlling the host control unit, the drive control unit, and the switch; and the data transfer method includes: a first step of receiving the data from the host; and a second step of having the switch execute processing for generating an error check code for the data and error check processing using the error check code, or distributing the processing for generating the error check code error and the error check processing among the host control unit, the drive control unit, the switch, and the controller and having them execute the processing for generating the error check code error and the error check processing.

The present invention makes it possible to perform necessary error processing properly by using a general-purpose switch as a switch for this invention, thereby realizing a storage apparatus and data transfer method capable of highly-reliable data transfer, while keeping costs down.

### BRIEF DESCRIPTION OF THE DRAWINGS

FIG. 1 is a block diagram illustrating the entire configuration of a computer system according to the first embodiment;

FIG. 2 is a block diagram illustrating a flow of data when write processing is executed by a conventional computer system;

FIG. 3 is a block diagram illustrating a flow of data when read processing is executed by a conventional computer system;

FIG. 4 is a block diagram illustrating a flow of data when write processing is executed by a computer system according to the first embodiment;

FIG. 5 is a flowchart illustrating a flow of the write processing executed by the computer system according to the first embodiment;

FIG. 6(A) shows the structure of DIF and FIG. 6(B) shows the structure of LA/LRC;

FIG. 7 is a block diagram illustrating a flow of data when read processing is executed by the computer system according to the first embodiment;

FIG. 8 is a flowchart illustrating a flow of the read processing executed by the computer system according to the first embodiment;

FIG. 9 is a flowchart illustrating a processing sequence for the first error processing;

FIG. 10 is a flowchart illustrating a processing sequence for the second error processing;

FIG. 11 is a block diagram illustrating a flow of data when write processing is executed by a computer system according to the second embodiment;

FIG. 12 is a flowchart illustrating a flow of the write processing executed by the computer system according to the second embodiment;

FIG. 13 is a block diagram illustrating a flow of data when read processing is executed by the computer system according to the second embodiment;

FIG. 14 is a flowchart illustrating a flow of the read processing executed by the computer system according to the second embodiment;

FIG. 15 is a block diagram illustrating a flow of data when write processing is executed by a computer system according to the third embodiment;

FIG. 16 is a flowchart illustrating a flow of the write processing executed by the computer system according to the third embodiment;

FIG. 17 is a block diagram illustrating a flow of data when read processing is executed by the computer system according to the third embodiment;

FIG. 18 is a flowchart illustrating a flow of the read processing executed by the computer system according to the third embodiment;

FIG. 19 is a block diagram illustrating a flow of data when write processing is executed by a computer system according to the forth embodiment;

FIG. 20 is a flowchart illustrating a flow of the write processing executed by the computer system according to the forth embodiment;

FIG. 21 is a block diagram illustrating a flow of data when read processing is executed by the computer system according to the forth embodiment;

FIG. 22 is a flowchart illustrating a flow of the read processing executed by the computer system according to the forth embodiment;

FIG. 23 is a block diagram illustrating a flow of data when write processing is executed by a computer system according to the fifth embodiment;

FIG. 24 is a flowchart illustrating a flow of the write processing executed by the computer system according to the fifth embodiment;

FIG. 25 is a block diagram illustrating a flow of data when write processing is executed by a computer system according to the sixth embodiment;

FIG. 26 is a flowchart illustrating a flow of the write processing executed by the computer system according to the sixth embodiment;

FIG. 27 is a block diagram illustrating a flow of data when write processing is executed by a computer system according to the seventh embodiment;

FIG. 28 is a flowchart illustrating a flow of the write processing executed by the computer system according to the seventh embodiment;

FIG. 29 is a block diagram illustrating a flow of data when write processing is executed by a computer system according to the eighth embodiment; and

FIG. 30 is a flowchart illustrating a flow of the write processing executed by the computer system according to the eighth embodiment.

### BEST MODE FOR CARRYING OUT THE INVENTION

Embodiments of the present invention will be explained below in detail with reference to the attached drawings.

### (1) First Embodiment

### (1-1) Configuration of Computer System according to First Embodiment

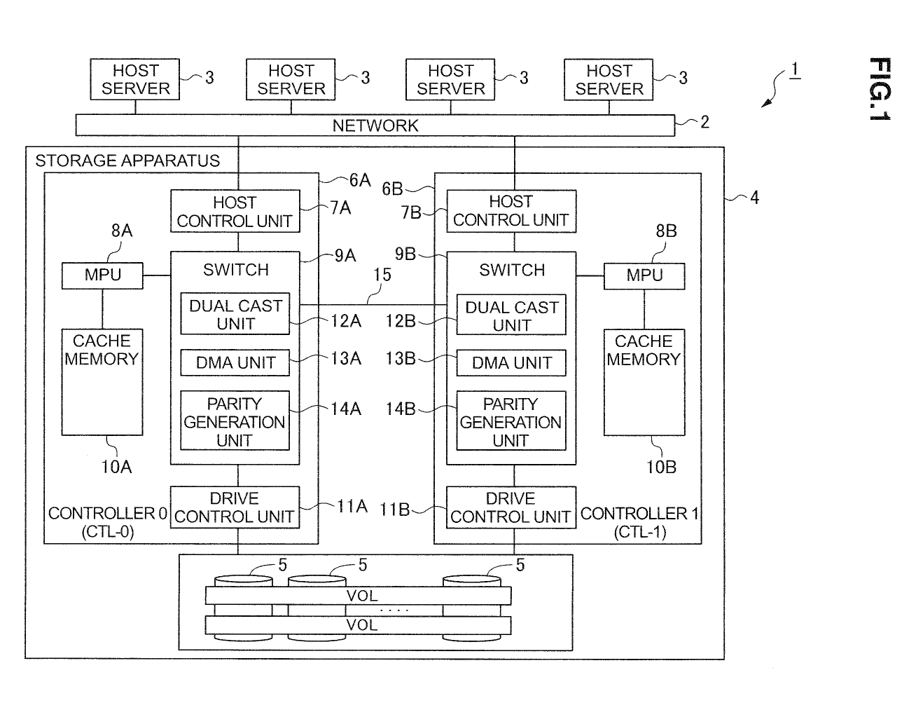

Reference numeral “1” in FIG. 1 represents a computer system as a whole according to the first embodiment. This computer system 1 is constituted from one or more host servers 3 and a storage apparatus 4 that are connected via a network 2.

The network 2 is, for example, a SAN (Storage Area Network), a LAN (Local Area Network), the Internet, public line(s), or private line(s). Communications between the host server 3 and the storage apparatus 4 via the network 2 are performed according to Fibre Channel Protocol if the network 2 is a SAN; or such communications are performed according to TCP/IP (Transmission Control Protocol/Internet Protocol) if the network 2 is a LAN.

The host server 3 is computer equipment including information processing resources such as a CPU (Central Processing Unit) and memory and is composed of, for example, a personal computer, a workstation, or a mainframe. The host server 3 includes information input devices such as a keyboard, a switch, a pointing device, and/or a microphone (not shown in the drawing), and information output devices such as a monitor display and/or a speaker (not shown in the drawing).

The storage apparatus 4 includes a plurality of storage devices 5 and two controllers 6A, 6B (a controller 6A for system 0 and a controller 6B for system 1) for controlling data input and/or output to/from the storage devices 5.

The storage devices 5 are composed of, for example, expensive disk devices such as SCSI (Small Computer System Interface) disks or inexpensive disk devices such as SATA (Serial AT Attachment) disks or optical disks.

These storage devices 5 are operated by the controller 6A for system 0 and the controller 6B for system 1 according to the RAID (Redundant Arrays of Inexpensive Disks) system. Incidentally, there may be only one controller. One or more logical volumes (hereinafter referred to as the “logical volumes”) VOL are set on a physical storage area provided by one or more storage devices 5. Data is stored in blocks of specified size in the logical volumes VOL, each block serving as a unit (hereinafter referred to as the “logical block”).

A unique identifier (hereinafter referred to as the “LUN [Logical Unit number]”) is assigned to each logical volume VOL. In this embodiment, data is input and/or output by specifying the address of the relevant logical block, using a combination of this LUN and a unique number assigned to each logical block (hereinafter referred to as the “LBA [Logical Block Address]”) as the address of the relevant logical block.

Each of the controller 6A for system 0 and the controller 6B for system 1 includes a host control unit 7A, 7B, an MPU (Micro Processing Unit) 8A, 8B, a switch 9A, 9B, a cache memory 10A, 10B, and a drive control unit 11A, 11B.

The host control unit 7A, 7B is an interface to the network 2 and includes information processing resources such as a CPU (Central Processing Unit) and memory. The host control unit 7A, 7B sends/receives write data, read data, and various commands to/from the host server 3 via the network 2.

The MPU 8A, 8B is a processor for controlling processing for inputting/outputting data to/from the storage devices 5 in response to a write command or a read command from the host server 3 and controls the host control unit 7A, 7B, the switch 9A, 9B, and the drive control unit 11A, 11B according to a microprogram read from the storage devices 5.

The switch 9A, 9B switches between a transfer source and a transfer destination when transferring data by selecting the transfer source and the transfer destination from the host control unit 7A, 7B, the cache memory 10A, 10B, and the drive control unit 11A, 11B. In this embodiment, the switch 9A, 9B is constructed by adding a DMA (Direct Memory Access) unit 13A, 13B and a parity generation unit 14A, 14B to a general-purpose PCIe (PCI [peripheral component interconnect] Express) switch equipped with a dual cast unit 12A, 12B.

The dual cast unit 12A, 12B has a dual cast function transferring write data and/or read data not only to the cache memory 10A, 10B for its own local system (system 0 or system 1) via the MPU 8A, 8B for the local system, but also to the controller 6B, 6B for the other system (system 1 or system 0) via a bus 15 described later. Furthermore, the DMA unit 13A, 13B has a DMA function directly accessing data stored in the cache memory 10A, 10B.

The parity generation unit 14A, 14B has a RAID error check function generating parity data for the RAID (hereinafter referred to as the “RAID parity”) with regard to the relevant write data, adding the RAID parity to the write data, and checking errors in the read data using the RAID parity.

Incidentally, a part or whole of the dual cast unit 12A, 12B, the DMA unit 13A, 13B, and the parity generation unit 14A, 14B may be constructed from hardware or software (the configuration in which a CPU [not shown in the drawing] for the switch 9A, 9B executes the corresponding programs). The dual cast function of the dual cast unit 12A, 12B as described later will be performed only when two controllers are used, and the dual cast function will not be performed when only one controller is used to operate the system.

The switch 9A/9B is connected via the bus 15 to the switch 9B/9A for the other system (system 0 or system 1) and can send/receive commands and data to/from the controller 9B/9A for the other system via this bus 15.

The cache memory 10A, 10B is used to temporarily store data transferred between the host control unit 7A, 7B and the drive control unit 11A, 11B. This cache memory 10A, 108 also stores the aforementioned microprogram, which is read from a specified storage device 5 at the time of activation of the storage apparatus 4, and various system information.

The drive control unit 11A, 11B is an interface to the storage devices 5 and includes information processing resources such as a CPU and memory. This drive control unit 11A, 11B writes write data to or reads read data from the address position designated by a write command or a read command in the relevant logical volume designated by the write command or the read command by controlling the corresponding storage devices 5 according to the write command or the read command sent from the host server 3 via the host control unit 7A, 7B.

### (1-2) Data Transfer Method for Storage Apparatus

Next, a data transfer method for the storage apparatus 4 will be explained. First, a flow of data transfer in a conventional storage apparatus will be explained below.

### (1-2-1) Data Transfer Method for Conventional Storage Apparatus

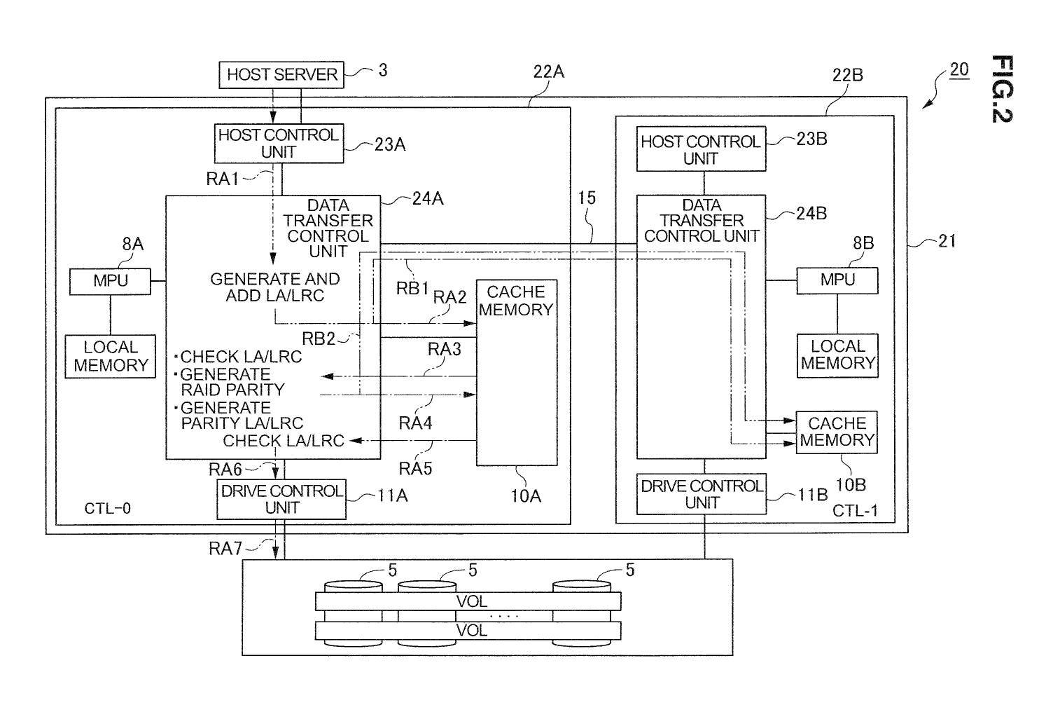

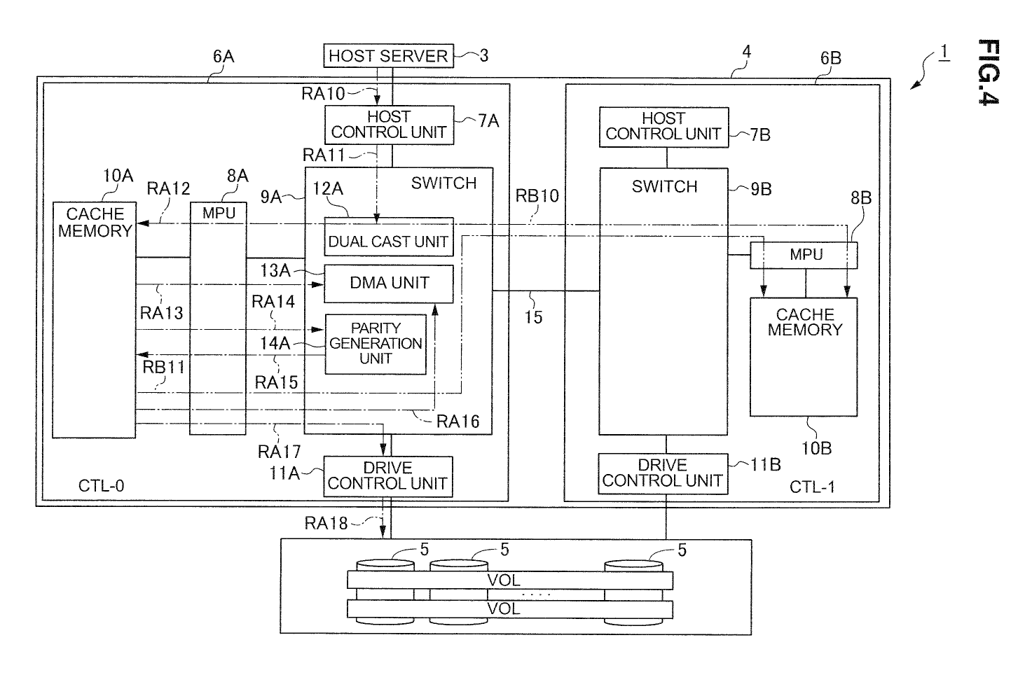

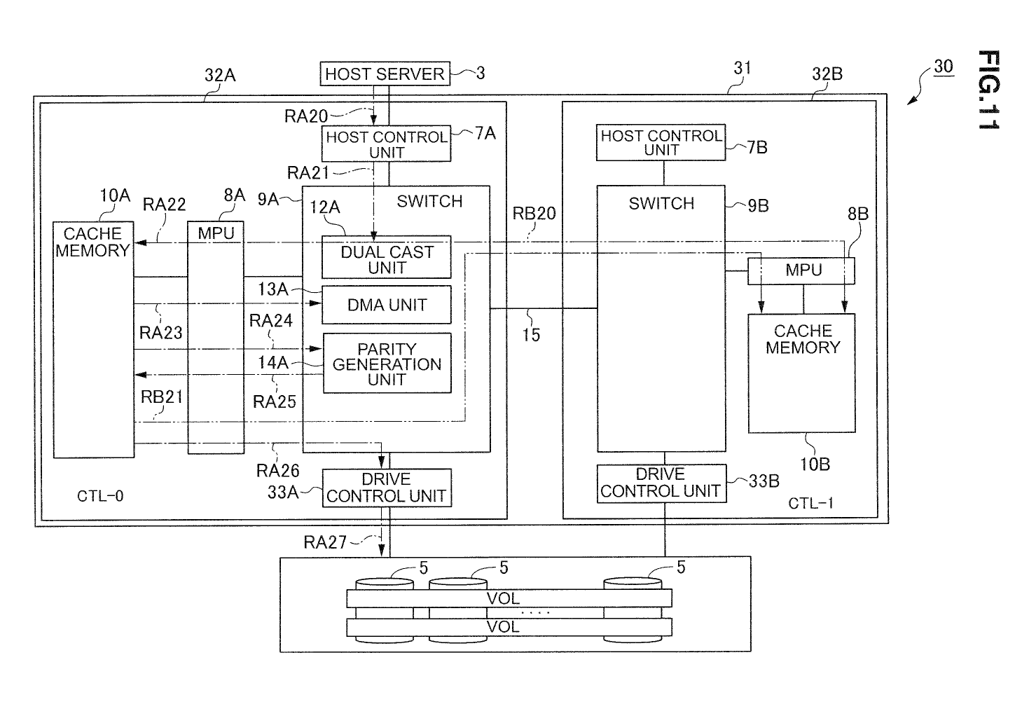

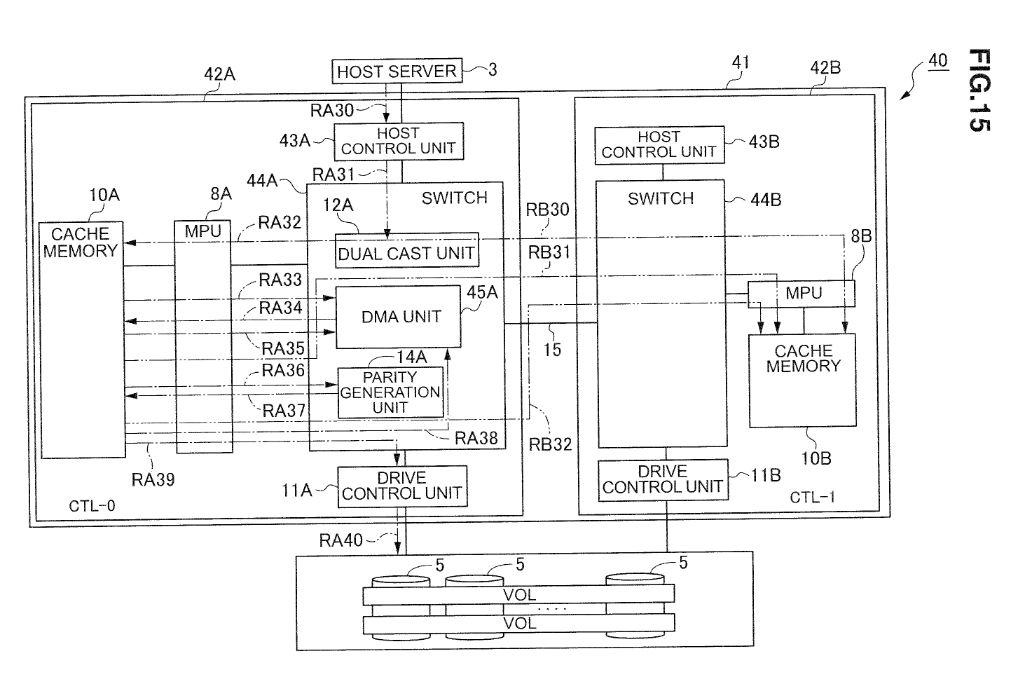

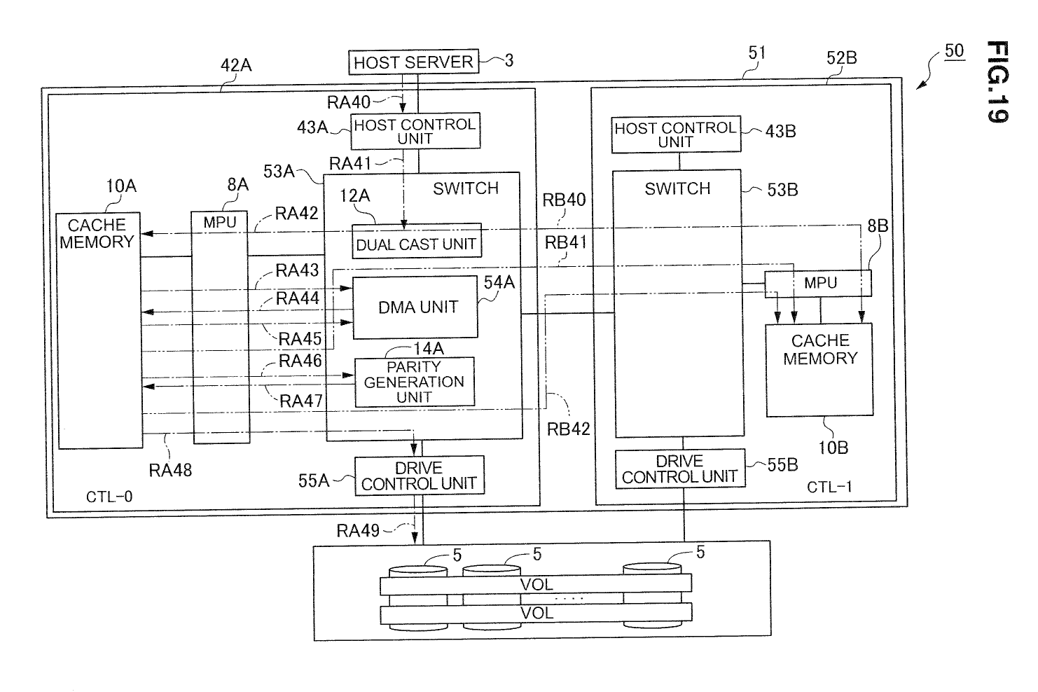

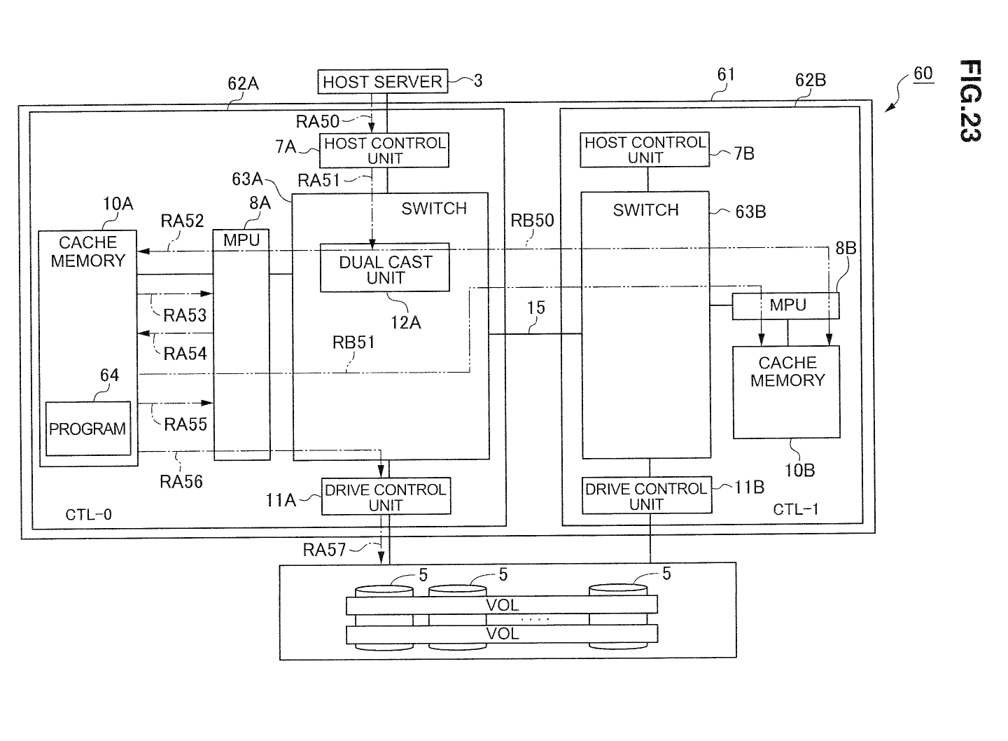

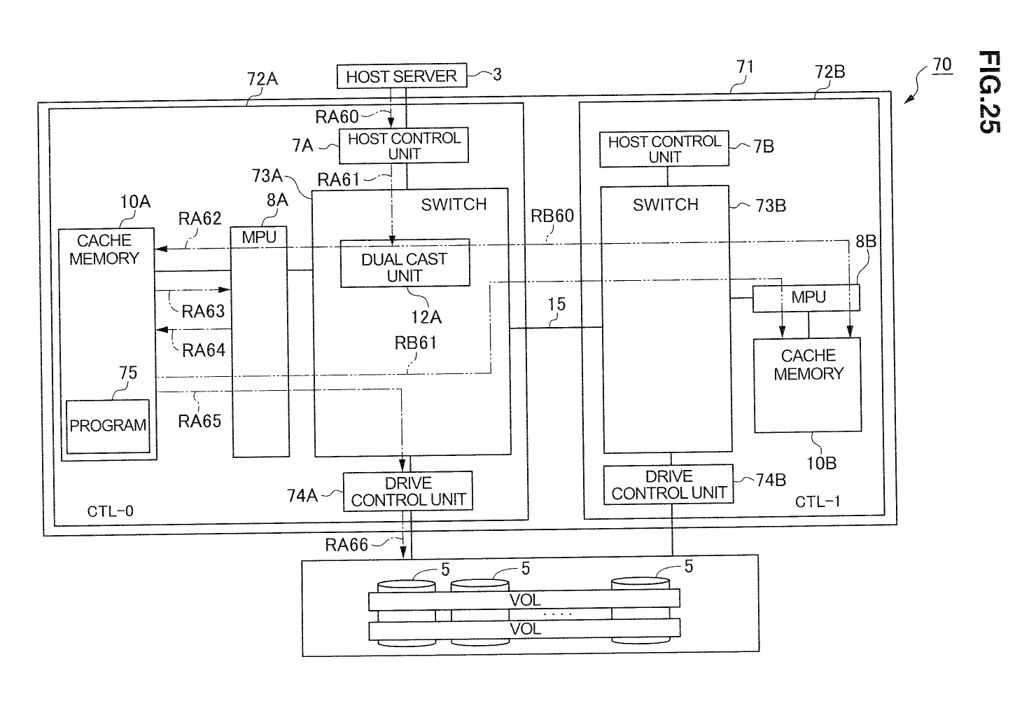

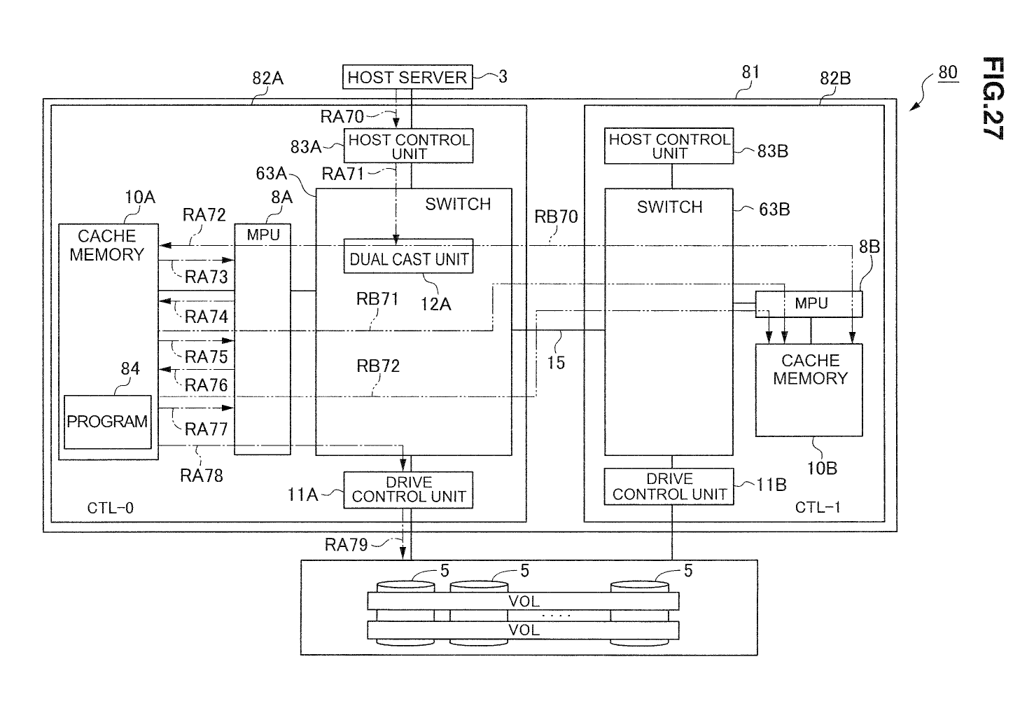

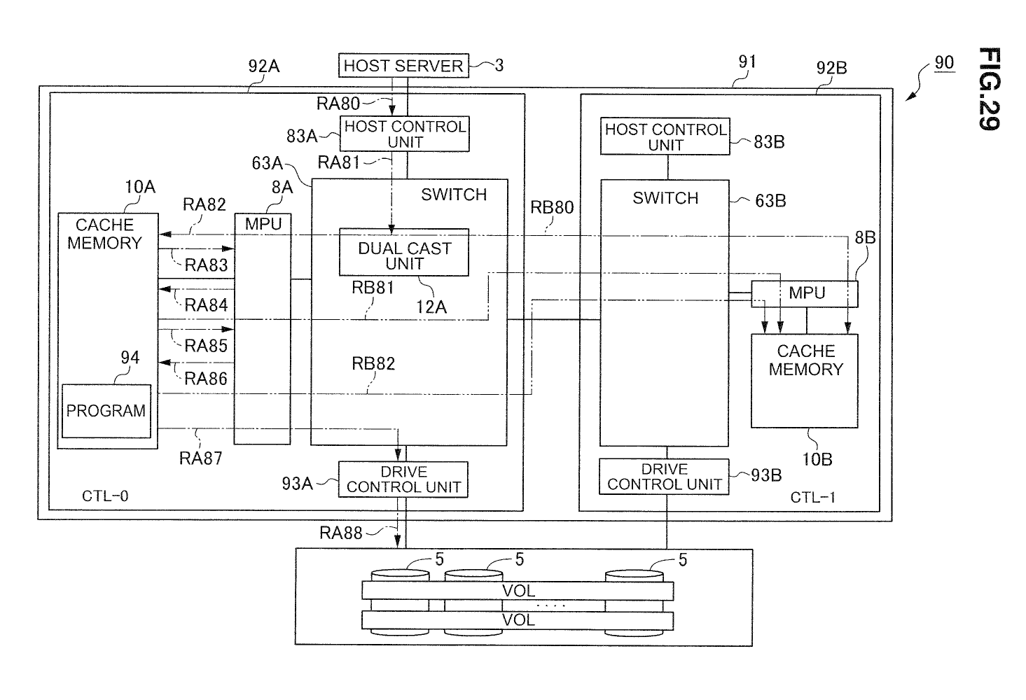

FIG. 2 in which elements corresponding to those in FIG. 1 are given the same reference numerals as those in FIG. 1 shows a flow of processing executed by a conventional storage apparatus 21 when a controller 22A for system 0 receives a write command and write data from a host server 3. In FIG. 2, a dashed-dotted line with arrows RA1 to RA7 represents a flow of, for example, write data written to or read from the cache memory 10A for the controller 22A in system 0 and/or the corresponding storage devices 5, and a dashed-two dotted line with arrows RB1 and RB2 represents a flow of write data written to the cache memory 10B for the controller 22B in system 1. The same applies to FIG. 4, FIG. 11, FIG. 15, FIG. 19, FIG. 23, FIG. 25, FIG. 27, and FIG. 29.

Components such as the host control unit 23A and the data transfer control unit 24A for the controller 22A in system 0 will be hereinafter referred to as the “host control unit 23A for system 0” and the “data transfer control unit 24A for system 0” whenever necessary, and components such as the host control unit 23B and the data transfer control unit 24B for the controller 22B in system 1 will be hereinafter referred to as the “host control unit 23B for system 1” and the “data transfer control unit 24B for system 1” whenever necessary.

After the host control unit 23A for system 0 in the conventional storage apparatus 21 receives a write command and write data from the host server 3, it sends the write data to the data transfer control unit 24A for system 0 (arrow RA1).

After receiving the write data, the data transfer control unit 24A for system 0 generates an error check code for the write data (hereinafter referred to as the “data error check code”) and adds the generated data error check code to the write data under the control of the MPU 8A, 8B. Subsequently, the data transfer control unit 24A for system 0 stores this write data in the cache memory 10A for system 0 (arrow RA2). Incidentally, for example, LA/LRC is used as the error check code in this case. The data transfer control unit 24A transfers the write data and its data error check code to the data transfer control unit 24B for system 1 and stores the write data and its data error check code also in the cache memory 10B for system 1 (arrow RB1).

Next, the data transfer control unit 24A for system 0 reads the write data and its data error check code from the cache memory 10A for system 0 (arrow RA3) and then executes processing for checking errors in the write data, using the data error check code. If no error is detected as a result of the error check processing, the data transfer control unit 24A for system 0 generates RAID parity for a group of data, which consists of the write data and its data error check code, and an error check code for this RAID parity (hereinafter referred to as the “parity error check code”) and stores the generated RAID parity and its parity error check code in the cache memory 10A for system 0 (arrow RA4).

The data transfer control unit 24A for system 0 transfers the RAID parity and its parity error check code to the data transfer control unit 24B for system 1 and stores the RAID parity and its parity error check code also in the cache memory 10B for system 1 (arrow RB2).

Subsequently, the data transfer control unit 24A for system 0 reads the write data and its data error check code as well as the RAID parity and its parity error check code from the cache memory 10A for system 0 (arrow RA5).

The data transfer control unit 24A for system 0 performs the processing for checking errors in the RAID parity using the parity error check code. If no error is detected as a result of the error check processing, the data transfer control unit 24A for system 0 transfers the write data and its data error check code as well as the RAID parity and its parity error check code to the drive control unit 11A for system 0 (arrow RA6).

Then, the drive control unit 11A for system 0 stores the write data and its data error check code as well as the RAID parity and its parity error check code in the logical volume VOL designated by the write command at the address position designated by the write command (arrow RA7).

If the above-described write processing terminates normally, the write data and its data error check code as well as the RAID parity and its parity error check code stored in the cache memory 10B for system 1 will be discarded later.

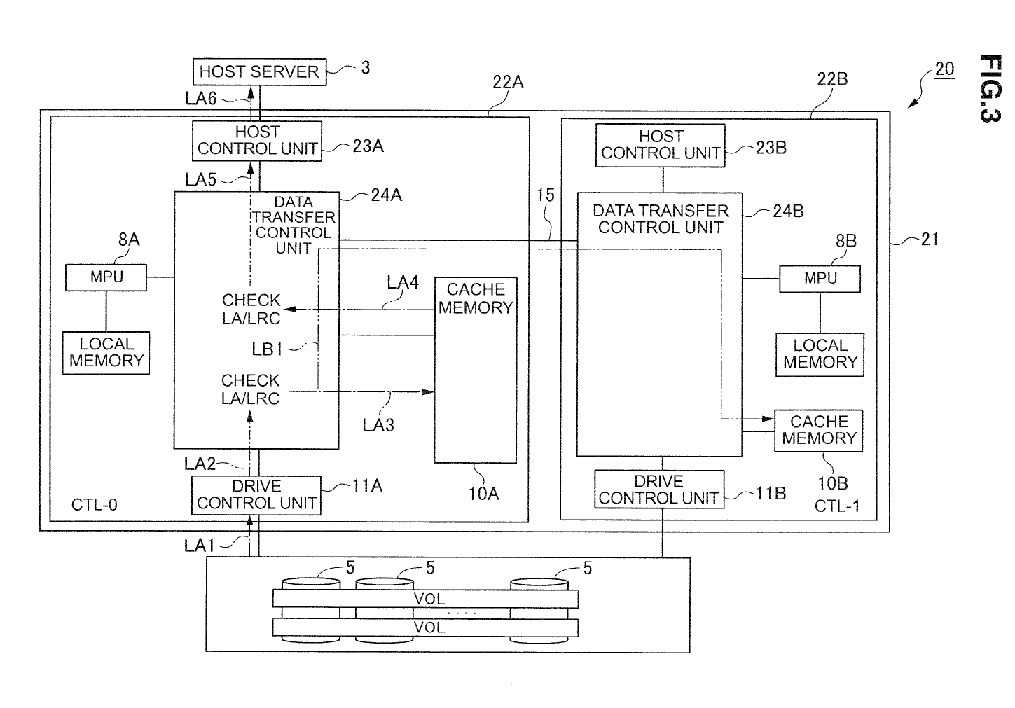

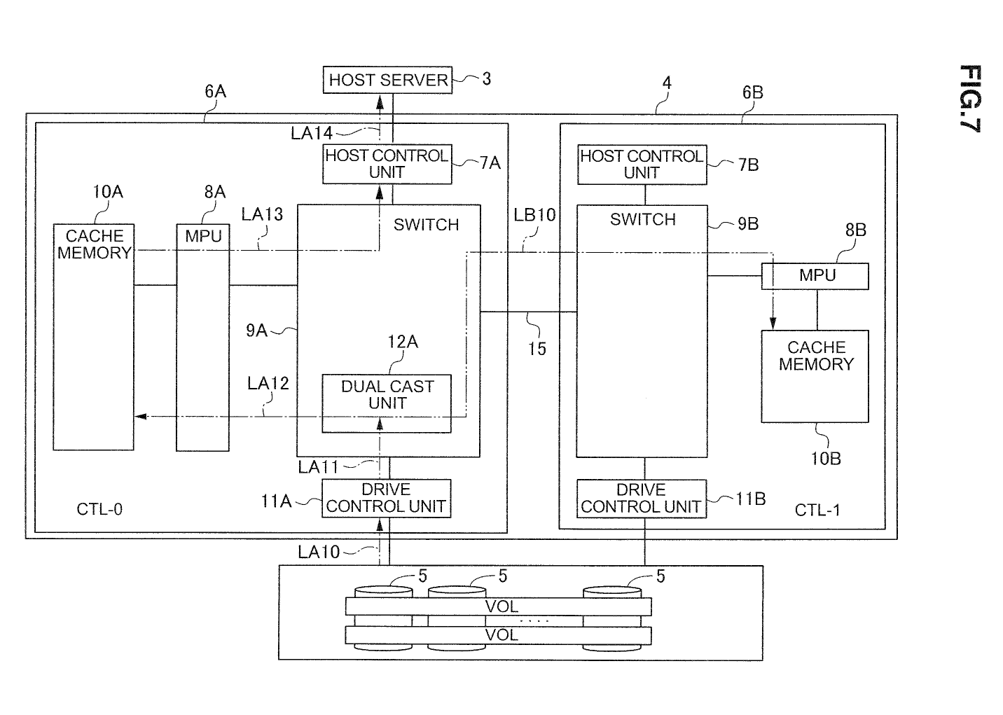

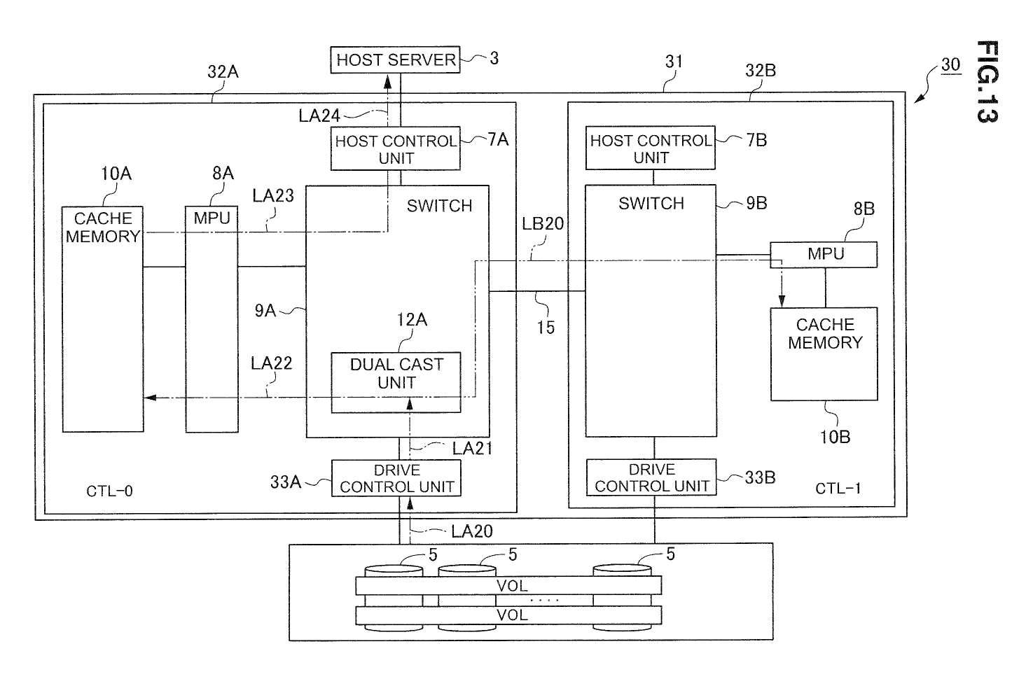

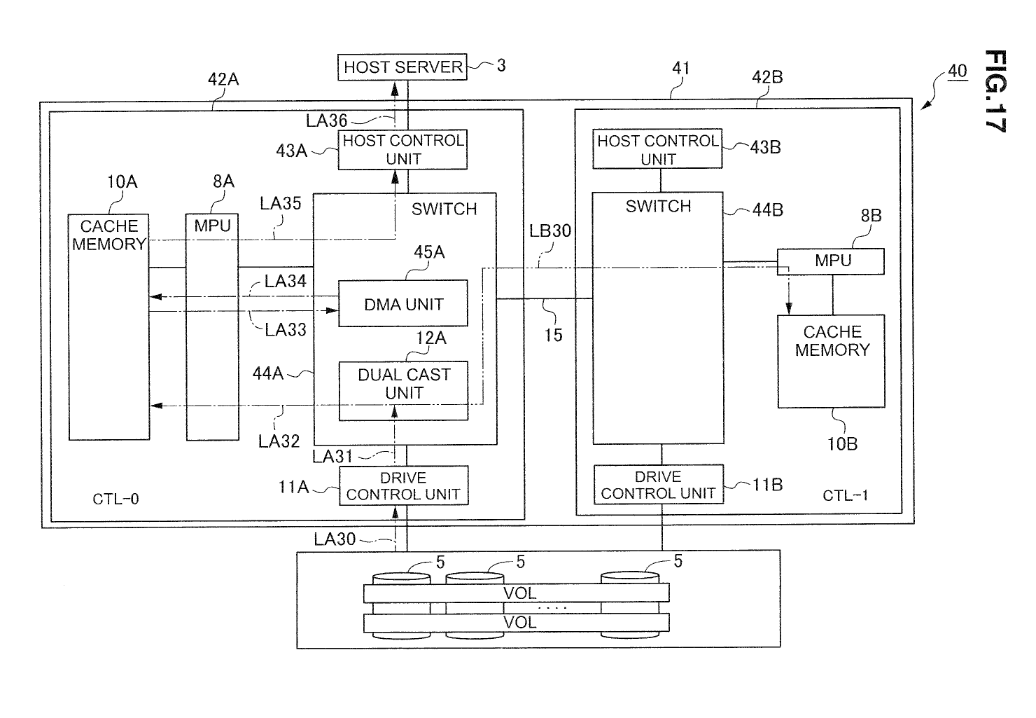

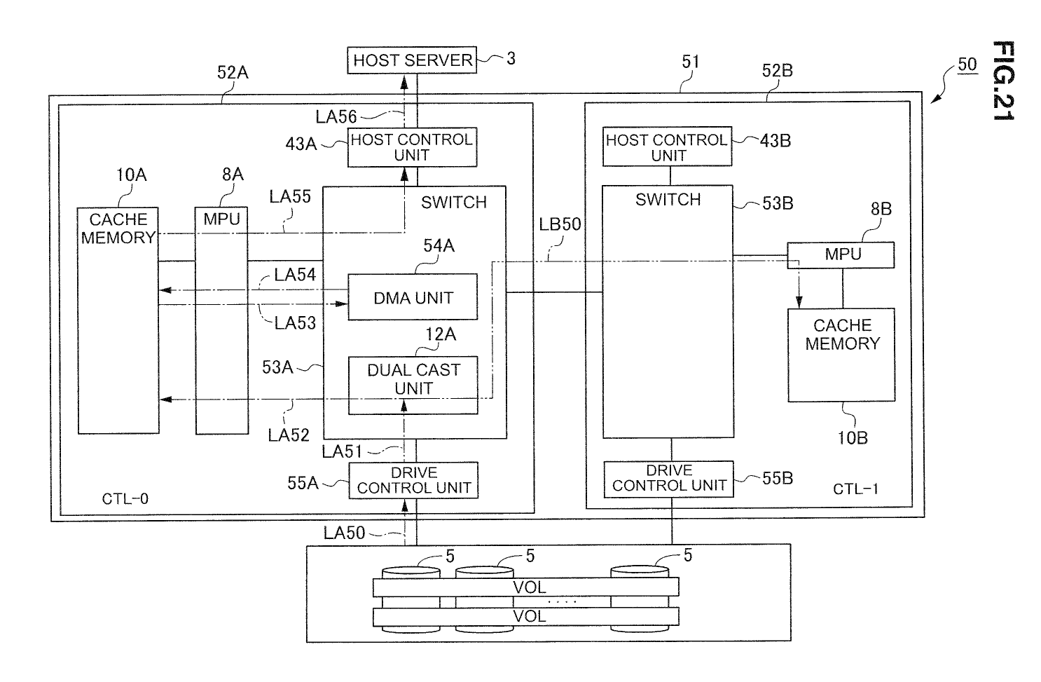

On the other hand, FIG. 3 in which elements corresponding to those in FIG. 2 are given the same reference numerals as those in FIG. 2 shows a flow of processing executed by the conventional storage apparatus 21 when the controller 22A for system 0 receives a read command from the host server 3. In FIG. 2, a dashed-dotted line with arrows LA1 to LA6 represents a flow of, for example, read data written to or read from the cache memory 10A for the controller 22A in system 0 and the corresponding storage devices 5, and a dashed-two dotted line with arrow LB1 represents a flow of read data written to the cache memory 10B for the controller 22B in system 1. The same applies to FIG. 7, FIG. 13, FIG. 17, and FIG. 21.

When the controller 22A for system 0 in the storage apparatus 21 receives a read command from the host server 3, the drive control unit 11A for system 0 first reads data and its data error check code from the logical volume VOL designated by this read command at the address position designated by the read command (arrow LA1) and sends the read data and its data error check code to the data transfer control unit 24A for system 0 (arrow LA2).

The data transfer control unit 24A for system 0 executes processing for checking errors in the read data using the data error check code; and if no error is detected as a result of the error check processing, the data transfer control unit 24A for system 0 stores the read data and its data error check code in the cache memory 10A for system 0 (arrow LA3).

Furthermore, the data transfer control unit 24A for system 0 transfers the read data and its data error check code to the data transfer control unit 24B for system 1 and stores the write data and its data error check code also in the cache memory 10B for system 1 (arrow LB1).

Subsequently, the data transfer control unit 24A for system 0 reads the read data and its data error check code from the cache memory 10A for system 0 (arrow LA4) and executes the processing for checking errors in the read data using the data error check code which has been read.

If no error is detected as a result of the error check processing, the data transfer control unit 24A for system 0 removes the data error check code from the read data and sends this read data to the host control unit 23A for system 0 (arrow LA5). Then, the host control unit 23A for system 0 transfers the read data to the host server 3 which is the transmission source of the read command (arrow LA6).

If the above-described read processing terminates normally, the read data and its data error check code stored in the cache memory 10B for system 1 will be discarded later.

With the conventional storage apparatus 21 described above, the error check code is added to write data or read data in order to secure reliability of data transfer in the storage apparatus 21, and the error check processing using this error check code is executed whenever necessary. The entire processing sequence for the error check processing is performed by the data transfer control unit 24A, 24B.

Therefore, with the conventional storage apparatus 21, it is necessary to custom-design the data transfer control unit 24A, 24B capable of executing the processing sequence for the above-described error check processing, and a general-purpose switch cannot be used as the data transfer control unit 24A, 24B. As a result, the conventional storage apparatus 21 has a problem of large processing load on the data transfer control unit 24A, 24B and possible deterioration of data input/output performance of the entire system depending on the performance of the data transfer control unit 24A, 24B. There is also a problem of high manufacturing costs for the entire storage apparatus 21 in order to use the data transfer control unit 24A, 24B with high data input/output performance.

Therefore, the storage apparatus 4 (FIG. 1) according to this embodiment is configured so that, from among the above-described error check processing, processing for, for example, generating the error check code and adding the generated error check code to the relevant write data is executed by the host control unit 7A, 7B (FIG. 1), thereby making it possible to use a customized PCIe switch as the switch 9A, 9B (FIG. 1). A data transfer method used in the storage apparatus 4 (the method for transferring write data or read data in the storage apparatus) will be explained below.

(1-2-2) Flow of Write Processing by Data Transfer Method according to First Embodiment

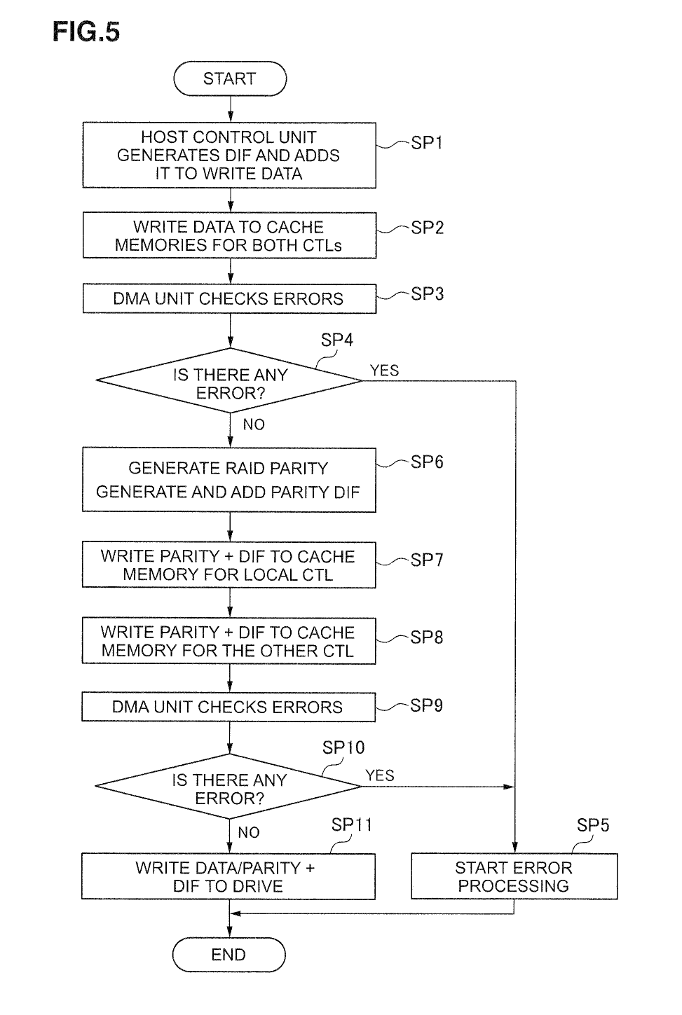

FIG. 4 shows a flow of processing executed in the storage apparatus 4 when the storage apparatus 4 according to this embodiment receives a write command and write data from the host server 3. The case where the controller 6A for system 0 receives a write command and write data will be explained below, and the same processing will also be executed when the controller 6B for system 1 receives write data. Furthermore. FIG. 5 is a flowchart schematically illustrating the flow of such processing.

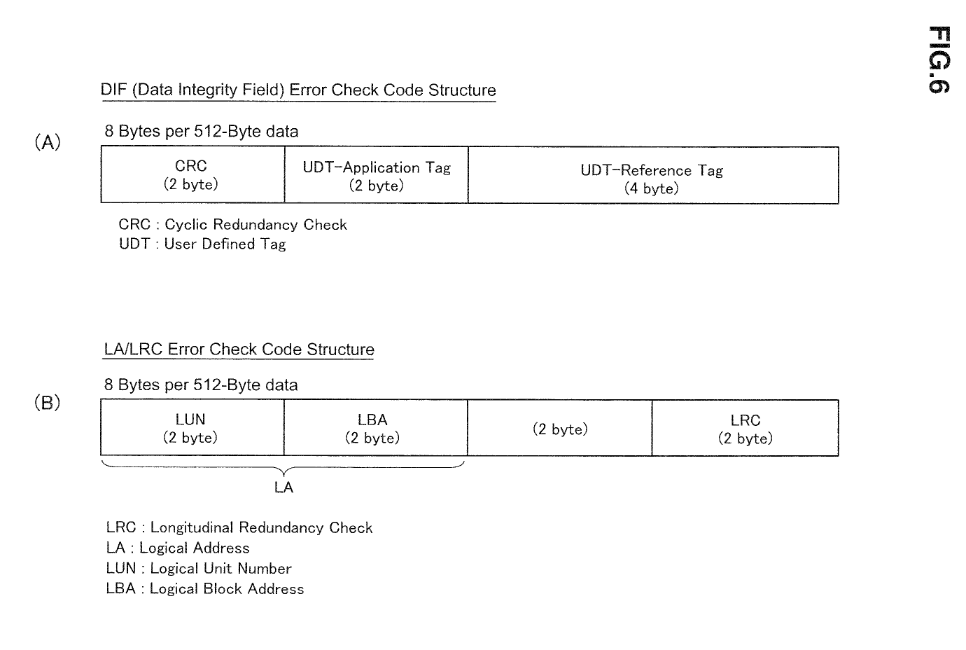

When the host control unit 7A for system 0 in the storage apparatus 4 receives a write command and write data from the host server 3 (arrow RA10 in FIG. 4), it generates a data error check code for this write data and adds the generated data error check code to that write data (SP1 in FIG. 5). Also, the host control unit 7A for system 0 sends the write data and the data error check code to the dual cast unit 12A for the switch 9A in system 0 (arrow RA11 in FIG. 4). Incidentally, a DIF (Data Integrity Field) is used as the data error check code in this embodiment as well as the second to eight embodiments explained later. FIG. 6(A) shows an example of the structure of a DIF and FIG. 6(B) shows an example of the structure of an LA/LRC.

The dual cast unit 12A stores the received write data and its data error check code in the cache memory 10A for system 0 and transfers the write data and its data error check code to the switch 9B for system 1, thereby having them stored also in the cache memory 10B for system 1 (arrows RAl2 and RB10 in FIG. 4 and SP2 in FIG. 5).

Subsequently, the DMA unit 13A for the switch 9A in system 0 reads the write data and its data error check code from the cache memory 10A for system 0 (arrow RA13 in FIG. 4) and then executes the processing for checking errors in the write data, using this data error check code (SP3 in FIG. 5).

If an error is detected as a result of the error check (SP4: YES), the MPU 8A for system 0 starts specified first error processing according to program stored in the cache memory 10A for system 0 (SP5 in FIG. 5). Then, the storage apparatus 4 terminates this write processing.

On the other hand, if no error is detected as a result of the error check (SP4: NO), the parity generation unit 14A for the switch 9A in system 0 reads the write data and its data error check code from the cache memory 10A for system 0 (arrow RA14 in FIG. 4). The parity generation unit 14A generates RAID parity for a group of data which consists of the write data and its data error check code, and also generates a parity error check code for this RAID parity and adds it to that RAID parity (SP6 in FIG. 5).

The parity generation unit 14A stores the thus-obtained RAID parity and its parity error check code in the cache memory 10A for system 0 (arrow RA15 in FIG. 4 and SP7 in FIG. 5). Next, the MPU 8A reads the RAID parity and its parity error check code from the cache memory 10A for system 0 and transfers them to the switch 9B for system 1, thereby having them stored also in the cache memory 10B for system 1 (arrow RB11 in FIG. 4 and SP8 in FIG. 5).

Subsequently, the DMA unit 13A for the switch 9A reads the write data and its data error check code as well as the RAID parity and its parity error check code from the cache memory 10A for system 0 (arrow RA16 in FIG. 4) and then executes the processing for checking errors in the write data and the RAID parity, using the data error check code and the parity error check code (SP9 in FIG. 5).

If an error is detected as a result of the error check (SP10 in FIG. 5: YES), the MPU 8A for system 0 starts specified second error processing according to the program stored in the cache memory 10A for system 0 (SP5 in FIG. 5). Then, the storage apparatus 4 terminates this write processing.

On the other hand, if no error is detected as a result of the error check (SP10 in FIG. 5: NO), the switch 9A reads the write data and its data error check code as well as the RAID parity and its parity error check code from the cache memory 10A for system 0 and sends them to the drive control unit 11A (arrow RA17 in FIG. 4).

Thus, the drive control unit 11A stores the write data and its data error check code as well as the RAID parity and its parity error check code in the logical volume designated by the write command at the address position designated by the write command (SP11 in FIG. 5). Then, the storage apparatus 4 terminates this write processing.

Incidentally, if the above-described write processing terminates normally, the write data and its data error check code as well as the RAID parity and its parity error check code stored in the cache memory 10B for system 1 will be discarded later.

(1-2-3) Flow of Read Processing by Data Transfer Method according to First Embodiment

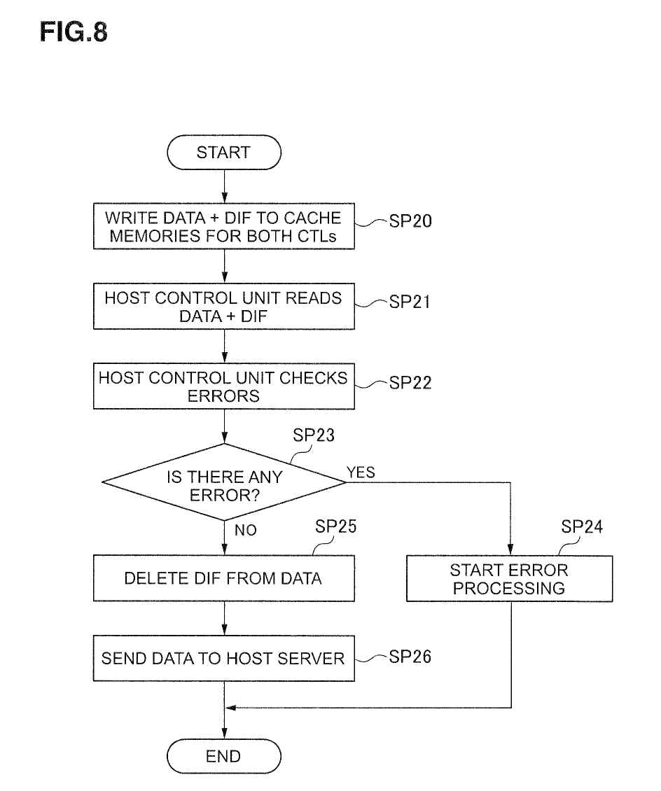

FIG. 7 shows a flow of processing executed in the storage apparatus 4 when the storage apparatus 4 according to this embodiment receives a read command from the host server 3. The case where the controller 6A for system 0 receives a read command will be explained below, and the same processing will also be executed when the controller 6B for system 1 receives a read command. Furthermore. FIG. 8 is a flowchart schematically illustrating the flow of such processing.

When the controller 6A for system 0 in the storage apparatus 4 receives a read command from the host server 3, the drive control unit 11A for system 0 reads data and its data error check code from the logical volume VOL designated by the read command at the address position designated by the read command (arrow LA10 in FIG. 7), and sends the data (read data) and its data error check code, which have been read, to the dual cast unit 12A for the switch 9A in system 0 (arrow LA11 in FIG. 7).

The dual cast unit 12A stores the received read data and its data error check code in the cache memory 10A for system 0 and transfers the read data and its data error check code to the switch 9B for system 1, thereby having them stored also in the cache memory 10B for system 1 (arrows LA12 and LB10 in FIG. 7 and SP20 in FIG. 8).

Subsequently, the host control unit 7A for system 0 reads the read data and its data error check code from the cache memory 10A for system 0 (arrow LA13 in FIG. 7 and SP21 in FIG. 8) and then executes the processing for checking errors in the read data, using this data error check code (SP22 in FIG. 8).

If an error is detected as a result of the error check (SP23: YES), the MPU 8A for system 0 starts the aforementioned first error processing according to the program stored in the cache memory 10A for system 0 (SP24 in FIG. 8). Then, the storage apparatus 4 terminates this read processing.

On the other hand, if no error is detected as a result of the error check (SP23: NO), the host control unit 7A for system 0 deletes the data error check code from the read data (SP25 in FIG. 8) and sends this read data to the host server 3 which is the transmission source of the read command (arrow LA14 in FIG. 7 and SP26 in FIG. 8). Then, the storage apparatus 4 terminates this read processing.

Incidentally, if the above-described read processing terminates normally, the read data with the data error check code added thereto stored in the cache memory 10B for system 1 will be discarded later.

### (1-2-3) Error Processing

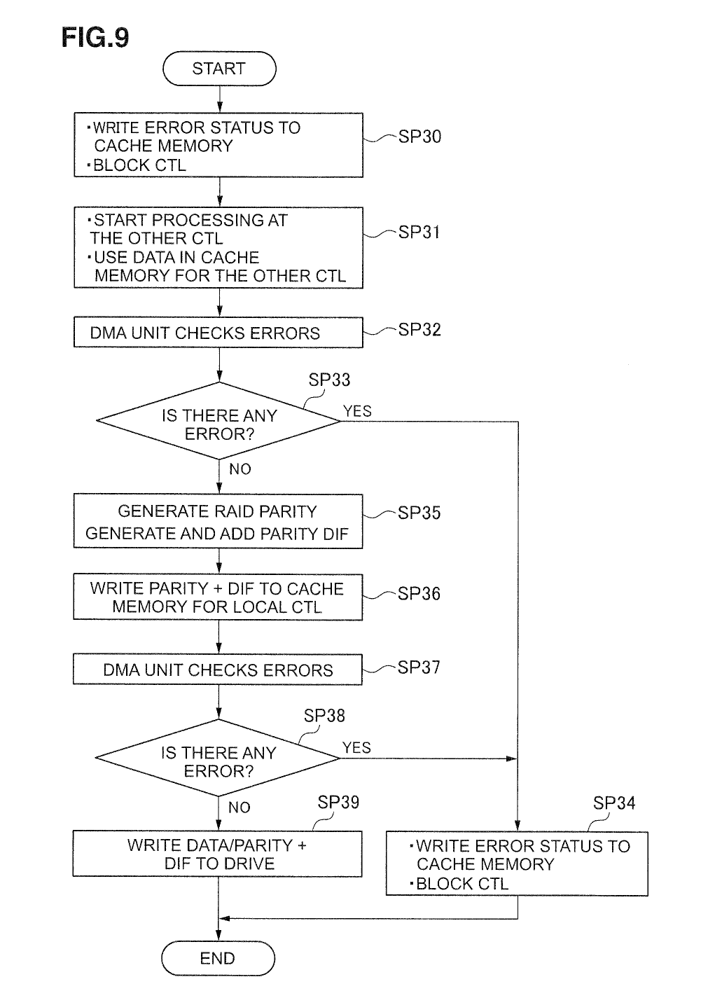

Next, the first error processing executed in step SP5 in FIG. 5 will be explained. FIG. 9 is a flowchart illustrating the details of the first error processing.

If an error is detected as a result of the error check in step SP3 in FIG. 5 (SP4 in FIG. 5: YES), the DMA unit 13A for system 0 starts the first error processing shown in FIG. 9, writes the error status in a specified area in the cache memory 10A for system 0 (hereinafter referred to as the “check result storage area”), and issues an error notice to the controller 6B for system 1. Subsequently, the MPU 8A blocks the controller 6A for the local system (SP30).

After receiving the error notice, the controller 6B for system 1 starts the write processing (SP31). First, the DMA unit 13B for the switch 9B reads the write data and its data error check code stored in the cache memory 10B for system 1 and executes the processing for checking errors in the write data, using the data error check code (SP32).

If an error is detected as a result of the error check (SP33: YES), the DMA unit 13B writes the error status in the check result storage area in the cache memory 10B for system 1 and then blocks the controller 10B for system 1, thereby terminating the first error processing.

On the other hand, if no error is detected as a result of the error check (SP33: NO), the controller 6B for system 1 executes processing in steps SP35 to SP39 in FIG. 9 in the same manner as in steps SP6 to SP11 in FIG. 5 and stores the write data and its data error check code as well as the RAID parity and its parity error check code in the cache memory 10B for system 1. Subsequently, the controller 6B for system 1 terminates this write processing.

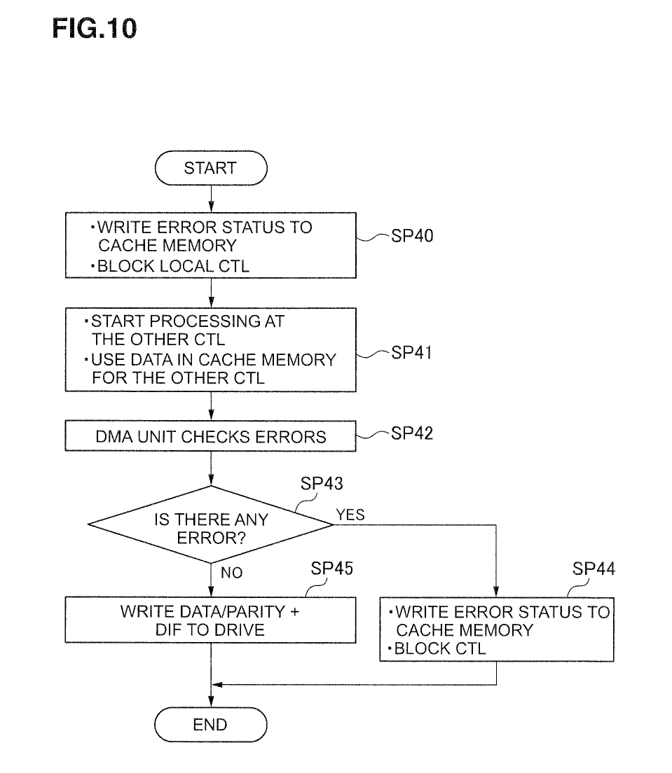

On the other hand, FIG. 10 is a flowchart illustrating the details of the second error processing executed in step SP10 in FIG. 5.

If an error is detected as a result of the error check in step SP9 in FIG. 5 (SP10 in FIG. 5: YES), the DMA unit 13A for system 0 starts the second error processing shown in FIG. 10, writes the error status in the check result storage area in the cache memory 10A for system 0 and issues an error notice to the controller 6B for system 1. Subsequently, the DMA unit 13A blocks the controller 6A for the local system (SP40).

After receiving the error notice, the controller 6B for system 1 starts the write processing (SP41). First, the DMA unit 13B for the switch 9B reads the write data and its data error check code stored in the cache memory 10B for system 1 and executes the processing for checking errors in the write data, using the data error check code (SP42).

If an error is detected as a result of the error check (SP43: YES), the DMA unit 13B writes the error status in the check result storage area in the cache memory 10B for system 1 and then blocks the controller 10B for system 1, thereby terminating the second error processing.

On the other hand, if no error is detected as a result of the error check (SP43: NO), the DMA unit 13B writes the write data and its data error check code as well as the RAID parity and its parity error check code via the drive control unit 11A in the logical volume VOL designated by the write command at the address position designated by the write command (SP45). Then, the above-described write processing terminates.

### (1-3) Effect of First Embodiment

With the storage apparatus 4 according to this embodiment as described above, the data error check code and the parity error check code are added by the host control unit 7A, 7B or the parity generation unit 14A for the switch 9A, 9B and the error check processing using the data error check code or the parity error check code is executed by the DMA unit 13A for the switch 9A, 9B.

As a result, this embodiment makes it possible to use a customized PCIe switch as the switch 9A, 9B and perform the necessary error check processing whenever necessary. Thus, highly-reliable data transfer can be performed while keeping costs low.

Since the host control unit 7A, 7B adds the error check code in this embodiment, data transfer between the host control unit 7A, 7B and the switch 9A, 9B can be secured and the reliability of data transfer can be further enhanced as compared to the conventional art.

### (2) Second Embodiment

FIG. 11 in which elements corresponding to those in FIG. 1 are given the same reference numerals as those in FIG. 1 shows a computer system 30 according to the second embodiment. The difference between this computer system 30 and the computer system 1 according to the first embodiment is that not only host control units 7A, 7B, but also drive control units 33A, 33B for controllers 32A, 32B in systems 0 and 1 in a storage apparatus 31 can execute the error check processing.

Due to the above-described difference in the configuration, a flow of write processing executed by the storage apparatus 31 in the computer system 30 is also different from that executed by the storage apparatus 4 according to the first embodiment (FIG. 1).

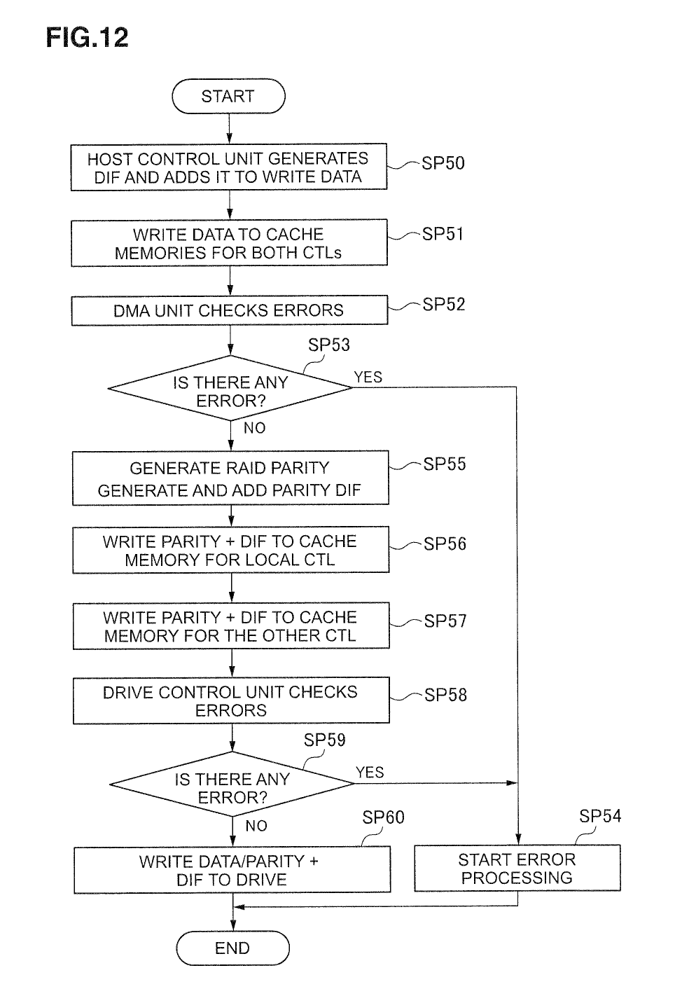

Incidentally, FIG. 11 shows a flow of data in the storage apparatus 31 when the controller 32A for system 0 in the storage apparatus 31 receives a write command and write data from the host server 3, and the same flow of data applies to the case where the controller 32B for system 1 receives a write command and write data. Furthermore. FIG. 12 is a flowchart schematically illustrating a flow of write processing executed by the storage apparatus 31 according to the second embodiment.

The flow of data indicated with arrows RA20 to RA25, arrow RA27, arrow RB20, and arrow RB21 in FIG. 11 is the same as that indicated with arrows RA10 to RA15, arrow RA18, arrow RB10, and arrow RB11 in FIG. 4. Processing executed in steps SP50 to SP57, step SP59, and step SP60 is the same as that executed in steps SP1 to SP8, step SP10, and step SP11 in FIG. 5.

The difference between the second embodiment and the first embodiment is that while the DMA unit 13A for the switch 9A executes the processing for checking errors in the RAID parity in the storage apparatus 4 according to the first embodiment, the drive control unit 33A executes the error check processing in the storage apparatus 31 according to the second embodiment.

Specifically speaking, after the RAID parity for a group of data, which consists of the write data and its data error check code, and its parity error check code are stored in the cache memory 10B for system 1 in the storage apparatus 31 according to the second embodiment (arrow RB21 in FIG. 11 and SP57 in FIG. 12), the drive control unit 33A for system 0 reads the write data and its data error check code as well as the RAID parity thereof and its parity error check code from the cache memory 10A for system 0. Then, the drive control unit 33A for system 0 executes the processing for checking errors in the write data and the RAID parity, using the data error check code and the parity error check code which have been read as described above (SP58 in FIG. 12).

If an error is detected as a result of the error check (8P59 in FIG. 12: YES), the MPU 8A for system 0 starts the aforementioned first error processing according to the program stored in the cache memory 10A for system 0 (SP54 in FIG. 12). Subsequently, the storage apparatus 31 terminates this write processing.

On the other hand, if no error is detected as a result of the error check (SP59 in FIG. 12: NO), the drive control unit 33A for system 0 stores the write data and its data error check code as well as the RAID parity thereof and its parity error check code, which have been read from the cache memory 10A for system 0, in the logical volume VOL designated by the write command at the address position designated by the write command (SP60 in FIG. 12). Subsequently, the storage apparatus 31 terminates this write processing.

Incidentally, if the above-described write processing terminates normally, the write data and its data error check code as well as the RAID parity thereof and its parity error check code stored in the cache memory 10B for system 1 will be discarded later.

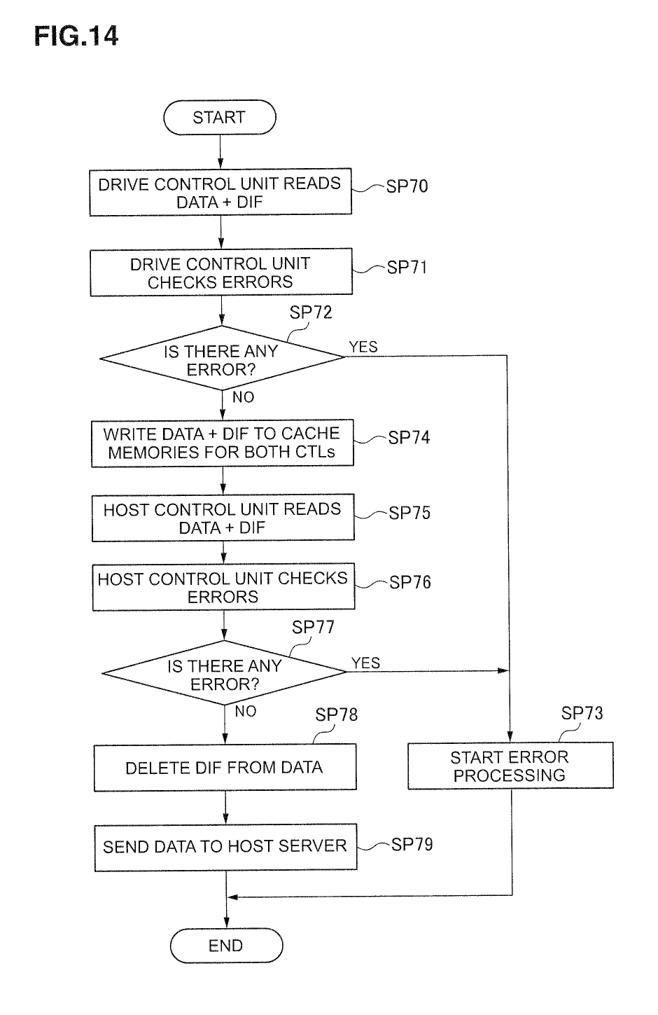

On the other hand. FIG. 13 shows a flow of processing executed in the storage apparatus 31 according to the second embodiment when the storage apparatus 31 receives a read command from the host server 3. Furthermore, FIG. 14 is a flowchart schematically illustrating a flow of such processing.

The flow of data indicated with arrows L/\20 to LA24 and arrow LB20 in FIG. 13 is the same as that indicated with arrows LA10 to LA14 and arrow LB10 in FIG. 7. Processing executed in steps SP74 to SP79 in FIG. 14 is completely the same as that in steps SP20 to SP26 in FIG. 8. The difference between the first embodiment and the second embodiment is that while the processing for checking errors in the read data is executed by the DMA unit 13A, 13B according to the first embodiment, the processing for checking errors in the read data is executed by the drive control unit 11A according to the second embodiment.

Specifically speaking, in the case of the storage apparatus 31 according to the second embodiment, the drive control unit 33A reads, in response to a read command from the host server 3, read data and its data error check code from the logical volume VOL designated by the read command (LA20 in FIG. 13 and SP70 in FIG. 14).

Then, the drive control unit 33A executes the processing for checking errors in the read data, using the data error check code which has been read (SP71 in FIG. 14).

If an error is detected as a result of the error check (SP72 in FIG. 14: YES), the MPU 8A for system 0 starts the aforementioned first error processing according to the program stored in the cache memory 10A for system 0 (SP73 in FIG. 14). Subsequently, the storage apparatus 31 terminates this read processing.

On the other hand, if no error is detected as a result of the error check (SP72 in FIG. 14: NO), the storage apparatus 31 executes processing in steps SP74 to SP79 in FIG. 14 in the same manner as in steps SP20 to SP26 in FIG. 8.

Incidentally, if the above-described read processing terminates normally, the read data and its data error check code stored in the cache memory 10B for system 1 will be discarded later.

If the computer system 30 according to the second embodiment is used as described above, it is possible as in the case of the first embodiment to use a customized PCIe switch as the switch 9A, 9B and perform the necessary error check processing whenever necessary. Thus, highly-reliable data transfer can be performed while keeping costs low.

Since the drive control unit 33A, 33B executes the error check processing according to the second embodiment, data transfer between the cache memory 10A, 10B and the drive control unit 33A, 33B can be secured and the reliability of data transfer can be further enhanced as compared to the storage apparatus 4 according to the first embodiment.

Furthermore, since the drive control unit 33A, 33B executes the error check processing according to the second embodiment, it is possible to reduce processing load on the switch 9A, 9B by the amount of load borne by the drive control unit 33A, 33B as compared to the storage apparatus 4 according to the first embodiment.

### (3) Third Embodiment

### (3-1) Data Transfer Method according to Third Embodiment

FIG. 15 in which elements corresponding to those in FIG. 1 are given the same reference numerals as those in FIG. 1 shows the configuration of a computer system 40 according to the third embodiment. The difference between the computer system 40 and the computer system 1 according to the first embodiment is that host control units 43A, 43B for a storage apparatus 41 in the computer system 40 do not have a function generating an error check code, while DMA units 45A, 45B for switches 44A, 44B have the error check code generating function.

Due to the above-described difference in the configuration, a flow of write processing executed by the storage apparatus 41 in the computer system 40 according to the third embodiment is also different from that executed by the storage apparatus 4 according to the first embodiment.

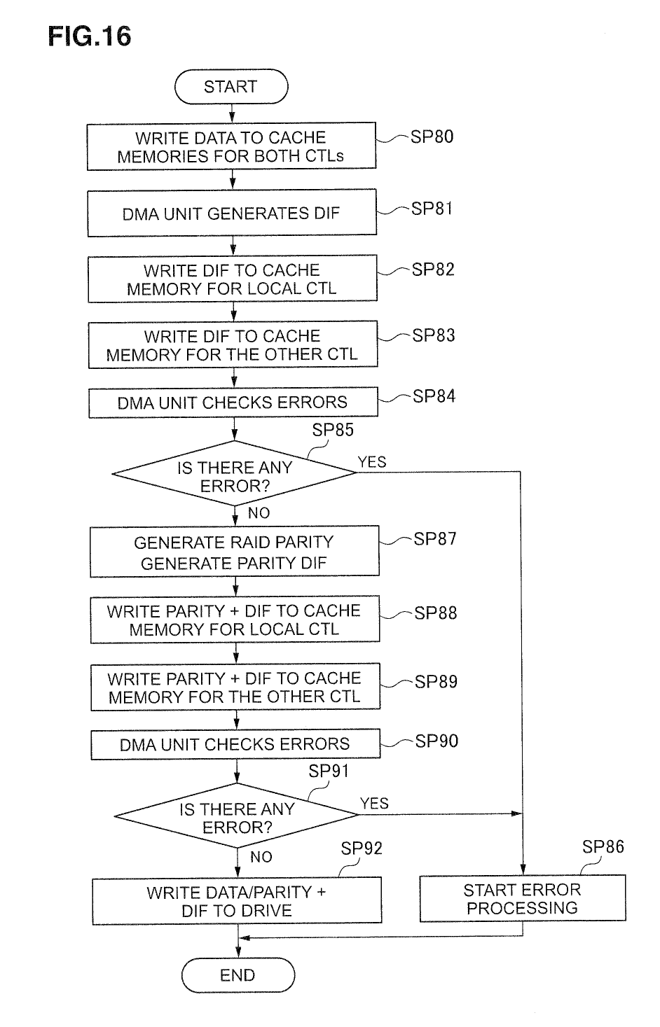

Incidentally, FIG. 15 shows a flow of data in the storage apparatus 41 when a controller 42A for system 0 in the storage apparatus 41 receives a write command and write data from the host server 3, and the same flow of data applies to the case where a controller 42B for system 1 receives a write command and write data. Furthermore. FIG. 16 is a flowchart schematically illustrating a flow of write processing executed by the storage apparatus 41 according to the third embodiment.

When the host control unit 43A for system 0 in the storage apparatus 41 receives a write command and write data from the host server 3 (arrow RA30 in FIG. 15), it sends the write data to the dual cast unit 12A for the switch 44A in system 0 (arrow RA31 in FIG. 15).

The dual cast unit 12A stores the received write data in the cache memory 10A for system 0 and transfers this write data to the switch 44B for system 1, thereby having the write data stored also in the cache memory 10B for system 1 (arrow RA32 and arrow RB30 in FIG. 4 and SP80 in FIG. 16).

Subsequently, the DMA unit 45A for the switch 44A in system 0 reads the write data from the cache memory 10A for system 0 (arrow RA33 in FIG. 15), generates a data error check code for this write data (SP81 in FIG. 16), and stores the generated data error check code in the cache memory 10A for system 0 (arrow RA34 in FIG. 15 and SP82 in FIG. 16).

Furthermore, the DMA unit 45A reads this data error check code from the cache memory 10A and sends it to the switch 44B for system 1, thereby having the data error check code stored also in the cache memory 10B for system 1 (arrow RB31 in FIG. 15 and SP83 in FIG. 16).

Subsequently, the storage apparatus 41 executes processing in steps SP84 to SP91 in the same manner as in steps SP3 to SP11 in FIG. 4. Therefore, the flow of data indicated with arrows RA35 to RA40 in FIG. 15 is the same as that indicated with arrows RA13 to RA18 in FIG. 4. Subsequently, the storage apparatus 41 terminates this write processing.

Incidentally, if the above-described write processing terminates normally, the write data and its data error check code as well as the RAID parity thereof and its parity error check code stored in the cache memory 10B for system 1 will be discarded later.

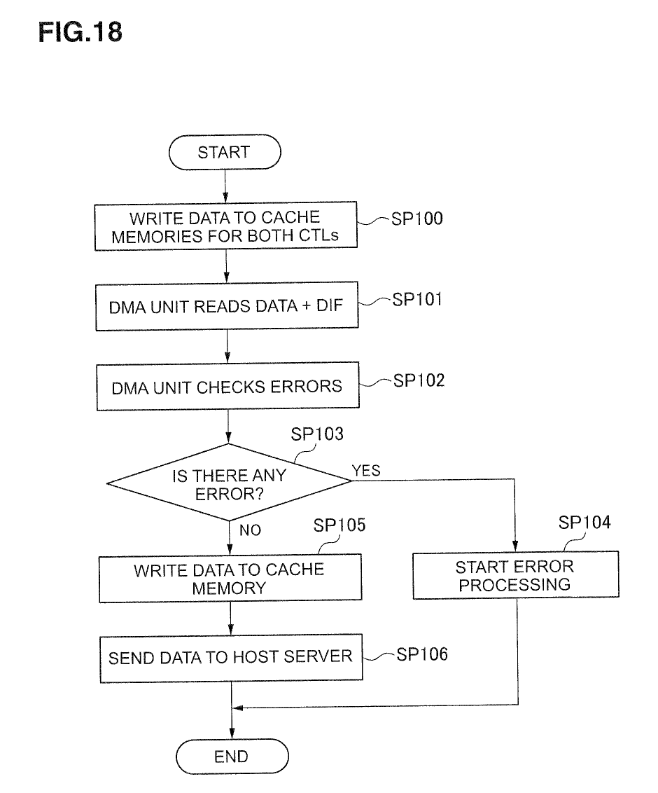

On the other hand. FIG. 17 shows a flow of processing in the storage apparatus 41 according to this embodiment when the storage apparatus 41 receives a read command from the host server 3. The case where the controller 42A for system 0 receives a read command will be explained below, and the same processing will be executed when the controller 42B for system 1 receives a read command. Furthermore, FIG. 18 is a flowchart schematically illustrating a flow of such processing.

When the controller 42A for system 0 in the storage apparatus 41 receives a read command from the host server 3, the drive control unit 11A for system 0 first reads data and its data error check code from the logical volume VOL designated by the read command at the address position designated by the read command (arrow LA30 in FIG. 17) and sends the read data and its data error check code to the dual cast unit 12A for the switch 44A in system 0 (arrow LA31 in FIG. 17).

The dual cast unit 12A stores the received read data and its data error check code in the cache memory 10A for system 0 and transfers the read data and its data error check code to the switch 44B for system 1, thereby having the read data and its data error check code stored also in the cache memory 10B for system 1 (arrow LA32 and arrow LB30 in FIG. 17 and SP100 in FIG. 18).

Subsequently, the DMA unit 45A for the switch 44A in system 0 reads the read data and its data error check code from the cache memory 10A for system 0 (arrow LA33 in FIG. 17 and SP101 in FIG. 18) and executes the processing for checking errors in the read data, using the data error check code (SP102 in FIG. 18).

If an error is detected as a result of the error check (SP103 in FIG. 18: YES), the MPU 8A for system 0 starts the aforementioned first error processing according to the program stored in the cache memory 10A for system 0 (8P104 in FIG. 18). Then, the storage apparatus 41 terminates this read processing.

On the other hand, if no error is detected as a result of the error check (SP103 in FIG. 18: NO), the DMA unit 45A deletes the data error check code which was added to the read data, and stores only the read data in the cache memory 10A for system 0 (arrow LA34 in FIG. 17 and SP105 in FIG. 18).

Subsequently, this read data is read by the host control unit 43A for system 0 (arrow LA35 in FIG. 17) and then sent to the host server 3 (arrow LA36 in FIG. 17 and SP106 in FIG. 18). Subsequently, the storage apparatus 41 terminates this read processing.

Incidentally, if the above-described read processing terminates normally, the read data and its data error check code stored in the cache memory 10B for system 1 will be discarded later.

### (3-2) Effect of Third Embodiment

As in the case of the first embodiment, the third embodiment makes it possible to use a customized PCIe switch as the switch 44A, 44B for the storage apparatus 41 and perform the necessary error check processing whenever necessary. Thus, highly-reliable data transfer can be performed while keeping costs low.

Since the switch 44A, 44B executes all the processing for generating the error check code for, for example, write data and checking errors in the relevant data using the error check code according to the third embodiment, load on the host control unit 43A, 43B and the drive control unit 11A, 11B can be reduced as compared to the storage apparatus 4 according to the first embodiment and the configurations of the host control unit 43A, 43B and the drive control unit 11A, 11B can be simplified.

### (4) Forth Embodiment

FIG. 19 in which elements corresponding to those in FIG. 15 are given the same reference numerals as those in FIG. 15 shows a computer system 50 according to the forth embodiment. The difference between the computer system 50 and the computer system 40 according to the third embodiment is that drive control units 55A, 55B for a storage apparatus 51 have an error check function.

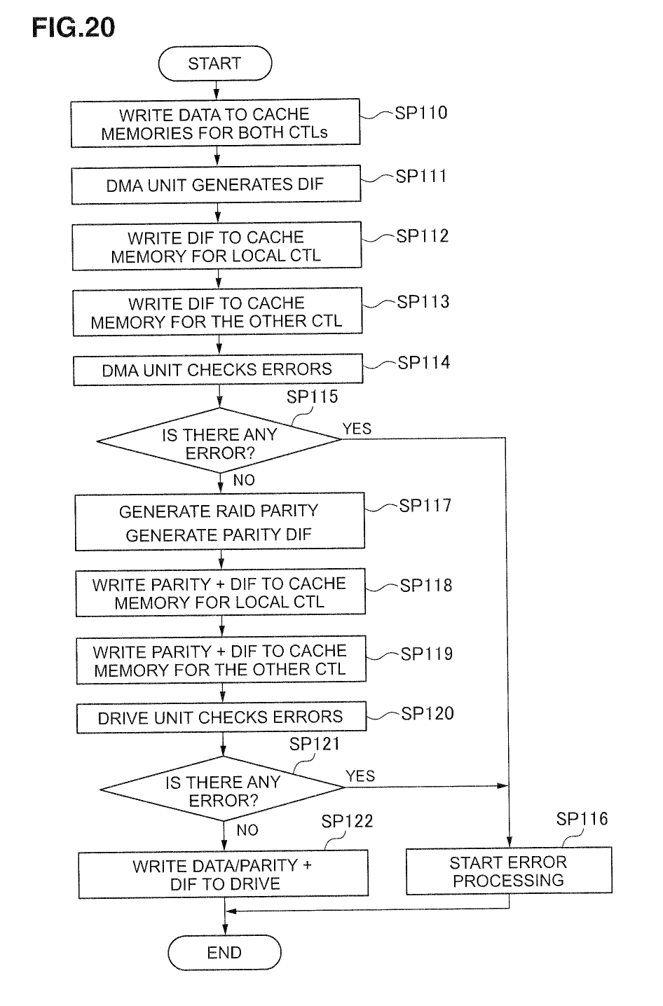

Due to the above-described difference in the configuration, a flow of write processing executed by a storage apparatus 51 in the computer system 50 is also different from that executed by the storage apparatus 41 according to the third embodiment. FIG. 20 is a flowchart schematically illustrating a flow of write processing executed by the storage apparatus 51 according to the fourth embodiment.

Incidentally, FIG. 19 shows a flow of write processing in the storage apparatus 51 when a controller 52A for system 0 in the storage apparatus 51 receives a write command and write data from the host server 3, and the same processing will be executed when a controller 52B for system 1 receives a write command and write data.

The flow of data indicated with arrows RA40 to RA47 and arrows RB40 to RB43 in FIG. 19 is the same as that indicated with arrows RA30 to RA37 and arrows RB30 to RB33 in FIG. 15. Furthermore, processing executed in steps SP110 to SP119 in FIG. 20 is completely the same as that executed in steps SP80 to SP89 in FIG. 16. The difference between the third embodiment and the fourth embodiment is that while the DMA unit 45A for the switch 44A executes the processing for checking errors in the RAID parity according to the third embodiment, the drive control unit 11A executes the error check processing according to the fourth embodiment.

Specifically speaking, after RAID parity and its parity error check code generated by the parity generation unit 14A for a switch 53 in system 0 is stored the cache memory 10A for system 0 in the storage apparatus 51 according to the fourth embodiment (arrow RA47 in FIG. 19 and SP119 in FIG. 20), the drive control unit 55A for system 0 reads the write data and its data error check code as well as the RAID parity thereof and its parity error check code from the cache memory 10A for system 0 (arrow RA48 in FIG. 19).

Then, the drive control unit 55A for system 0 executes the processing for checking errors in the write data and the RAID parity, using the data error check code and the parity error check code (SP120 in FIG. 20).

If an error is detected as a result of the error check (SP121 in FIG. 20: YES), the MPU 8A for system 0 starts the aforementioned first error processing according to the program stored in the cache memory 10A for system 0 (SP116 in FIG. 20). Subsequently, the storage apparatus 51 terminates this write processing.

On the other hand, if no error is detected as a result of the error check (SP121 in FIG. 20: NO), the drive control unit 55A for system 0 stores the write data and its data error check code as well as the RAID parity thereof and its parity error check code, which have been read from the cache memory 10A for system 0 as described above, in the logical volume VOL designated by the write command at the address position designated by the write command (arrow RA49 in FIG. 19 and SP122 in FIG. 20). Then, the storage apparatus 51 terminates this write processing.

Incidentally, if the above-described write processing terminates normally, the write data and its data error check code as well as the RAID parity thereof and its parity error check code stored in the cache memory 10B for system 1 will be discarded later.

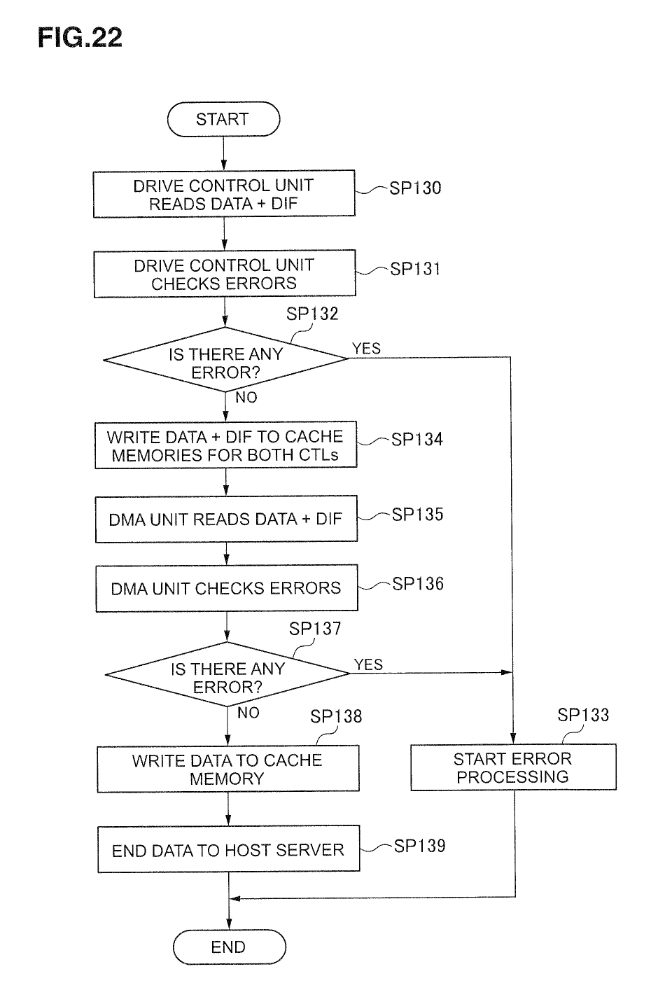

On the other hand, FIG. 21 shows a flow of processing executed in the storage apparatus 51 according to the fourth embodiment when the storage apparatus 51 receives a read command from the host server 3. The case where the controller 52A for system 0 receives a read command will be explained below, and the same processing will be executed when the controller 52B for system 1 receives a read command. Furthermore. FIG. 22 is a flowchart schematically illustrating a flow of such processing.

When the controller 52A for system 0 in the storage apparatus 51 receives a read command from the host server 3, the drive control unit 55A for system 0 first reads data and its data error check code from the logical volume VOL designated by the read command at the address position designated by the read command (arrow LA50 in FIG. 21 and SP130 in FIG. 22) and executes the processing for checking errors in the read data, using the data error check code (SP131 in FIG. 22).

If an error is detected as a result of the error check (SP132 in FIG. 22: YES), the MPU 8A for system 0 starts the aforementioned first error processing according to the program stored in the cache memory 10A for system 0 (SP133 in FIG. 22). Then, the storage apparatus 51 terminates this write processing.

On the other hand, if no error is detected as a result of the error check (SP132 in FIG. 22: NO), the drive control unit 55A sends the read data and its data error check code to the dual cast unit 12A for the switch 53A. The dual cast unit 12A then stores the received read data and its data error check code in the cache memory 10A for system 0 and transfers the read data and its data error check code to the switch 44B for system 1, thereby having the read data and its data error check code stored also in the cache memory 10B for system 1 (arrow LA52 and arrow LB50 in FIG. 21 and SP134 in FIG. 22).

Subsequently, the storage apparatus 51 executes steps SP135 to SP139 in FIG. 22 in the same manner as in steps SP100 to 8P106 in FIG. 18. Therefore, the flow of data indicated with arrows LA52 to LA56 in FIG. 21 is the same as that indicated with arrows LA33 to LA36 in FIG. 17. Subsequently, the storage apparatus 51 terminates this read processing.

Incidentally, if the above-described read processing terminates normally, the read data and its data error check code stored in the cache memory 10B for system 1 will be discarded later.

As in the case of the first embodiment, the fourth embodiment makes it possible to use a customized PCIe switch as the switch 53A, 53B for the storage apparatus 51 and perform the necessary error check processing whenever necessary. Thus, highly-reliable data transfer can be performed while keeping costs low.

Since the drive control unit 55A′ executes the error check processing according to the fourth embodiment, data transfer between the cache memory 10A, 10B and the drive control unit 55A, 55B can be also secured and the reliability of data transfer can be further enhanced as compared to the conventional art.

Furthermore, since the drive control unit 55A, 55B executes the error check processing as described above, load on the switch 53A, 53B can be reduced as compared to the storage apparatus 41 according to the third embodiment.

### (5) Fifth Embodiment

FIG. 23 in which elements corresponding to those in FIG. 4 are given the same reference numerals as those in FIG. 4 shows a computer system 60 according to the fifth embodiment. The difference between the computer system 60 according to the fifth embodiment and the computer system 1 according to the first embodiment is that a PCIe switch is used as switches 63A, 63B mounted in controllers 62A, 62B for systems 0 and 1 in a storage apparatus 61.

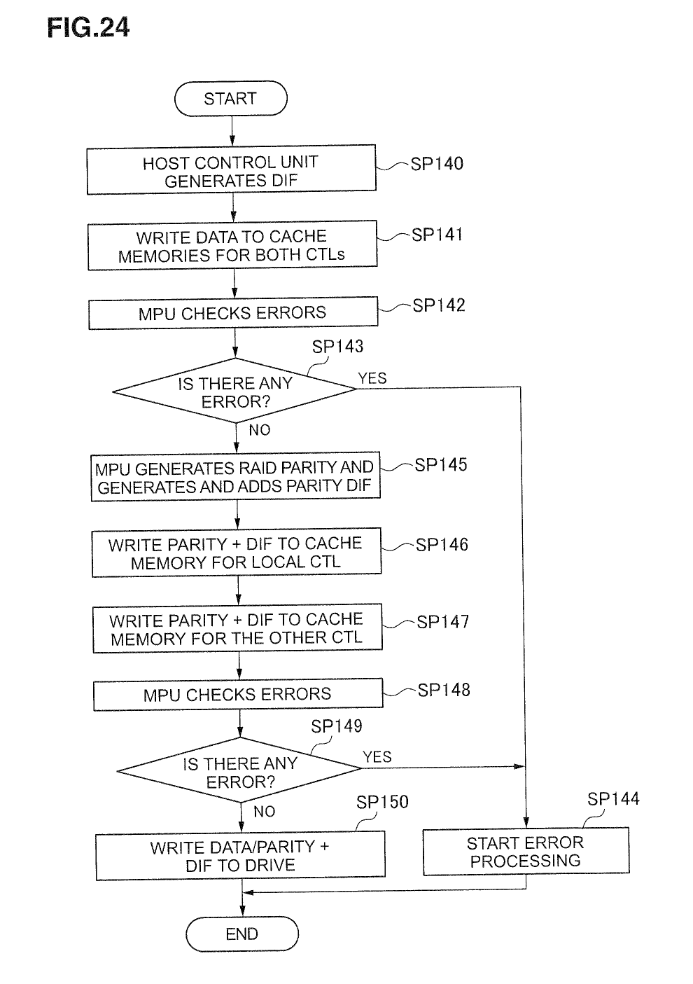

Another difference between the computer system 60 and the computer system 1 according to the first embodiment is that due to the above-described difference in the configuration, the processing for checking errors in write data or read data is executed by the MPU 8A for system 0 according to program 64 stored in the cache memory 10A for system 0. FIG. 24 is a flowchart schematically illustrating a flow of write processing executed by the storage apparatus 61 according to the fifth embodiment.

Incidentally, FIG. 23 shows a flow of processing in the storage apparatus 61 when the controller 62A for system 0 in the storage apparatus 61 receives a write command and write data from the host server 3, and the same processing will be executed when the controller 62B for system 1 receives a write command and write data.

After receiving a write command and write data from the host server 3 (arrow RA50 in FIG. 23), the host control unit 7A for system 0 in the storage apparatus 61 generates a data error check code for this write data and adds it to the write data. Also, the host control unit 7A for system 0 sends the write data and its data error check code to the dual cast unit 12A for a switch 63A (arrow RA51 in FIG. 23).

The dual cast unit 12A stores the write data and its data error check code, which were sent from the host control unit 7A for system 0, in the cache memory 10A for system 0 and transfers them to the switch 63B for system 1, thereby having them stored also in the cache memory 10B for system 1 (arrow RA52 and arrow RB50 in FIG. 23 and SP141 in FIG. 24).

Subsequently, the MPU 8A reads the write data and its data error check code from the cache memory 10A for system 0 according to program 64 stored in the cache memory 10A for system 0 (arrow RA53 in FIG. 23) and executes the processing for checking errors in the write data, using this data error check code (SP142 in FIG. 24).

If an error is detected as a result of the error check (SP143 in FIG. 24: YES), the MPU 8A for system 0 starts the aforementioned first error processing according to the program stored in the cache memory 10A for system 0 (SP143 in FIG. 24). Then, the storage apparatus 61 terminates this write processing.

On the other hand, if no error is detected as a result of the error check (SP143 in FIG. 24: NO), the MPU 8A generates RAID parity for a group of data which consists of the write data and its data error check code, and also generates a parity error check code for this RAID parity according to the program 64, and then adds the parity error check code to the RAID parity (SP145 in FIG. 24).

Subsequently, the MPU 8A writes this RAID parity and its parity error check code to the cache memory 10A for system 0 (arrow RA54 in FIG. 23 and SP146 in FIG. 24). Furthermore, the MPU 8A reads the RAID parity and its parity error check code from the cache memory 10A for system 0 and transfers them to the switch 63B for system 1, thereby having them stored in the cache memory 10B for system 1 (arrow RB51 in FIG. 23 and SP147 in FIG. 24).

Next, the MPU 8A reads the write data and its data error check code as well as the RAID parity thereof and its parity error check code from the cache memory 10A for system 0. Furthermore, the MPU 8A executes the processing for checking errors in the write data and the RAID parity using the data error check code and the parity error check code according to the program 64 stored in the cache memory 10A for system 0 (SP148 in FIG. 24).

If an error is detected as a result of the error check (SP149 in FIG. 24: YES), the MPU 8A for system 0 starts the aforementioned second error processing according to the program stored in the cache memory 10A for system 0 (SP144 in FIG. 24). Then, the storage apparatus 61 terminates this write processing.

On the other hand, if no error is detected as a result of the error check (SP149 in FIG. 24: NO), the MPU 8A reads the write data and its data error check code as well as the RAID parity and its parity error check code from the cache memory 10A for system 0 and sends them to the drive control unit 11A (arrow RA56 in FIG. 23).

Thus, the drive control unit 11A stores the write data and its data error check code as well as the RAID parity and its parity error check code in the logical volume VOL designated by the write command at the address position designated by the write command (SP150 in FIG. 24). Then, the storage apparatus 61 terminates this write processing.

Incidentally, if the above-described write processing terminates normally, the write data and its data error check code as well as the RAID parity thereof and its parity error check code stored in the cache memory 10B for system 1 will be discarded later.

With the computer system 60 according to the fifth embodiment as described above, the MPU 8A for the storage apparatus 61 executes the processing for generating the error check code and the error check processing using the error check code. As a result, it is possible to use a general-purpose PCIe switch as the switch 63A, 63B and perform highly-reliable data transfer while keeping costs low.

### (6) Sixth Embodiment

FIG. 25 in which elements corresponding to those in FIG. 23 are given the same reference numerals as those in FIG. 23 shows a computer system 70 according to the sixth embodiment. The difference between the computer system 70 and the storage apparatus 60 according to the fifth embodiment is that not only the host control units 7A, 7B, but also drive control units 74A, 74B have an error check function in controllers 72A, 72B for systems 0 and 1 in a storage apparatus 71.

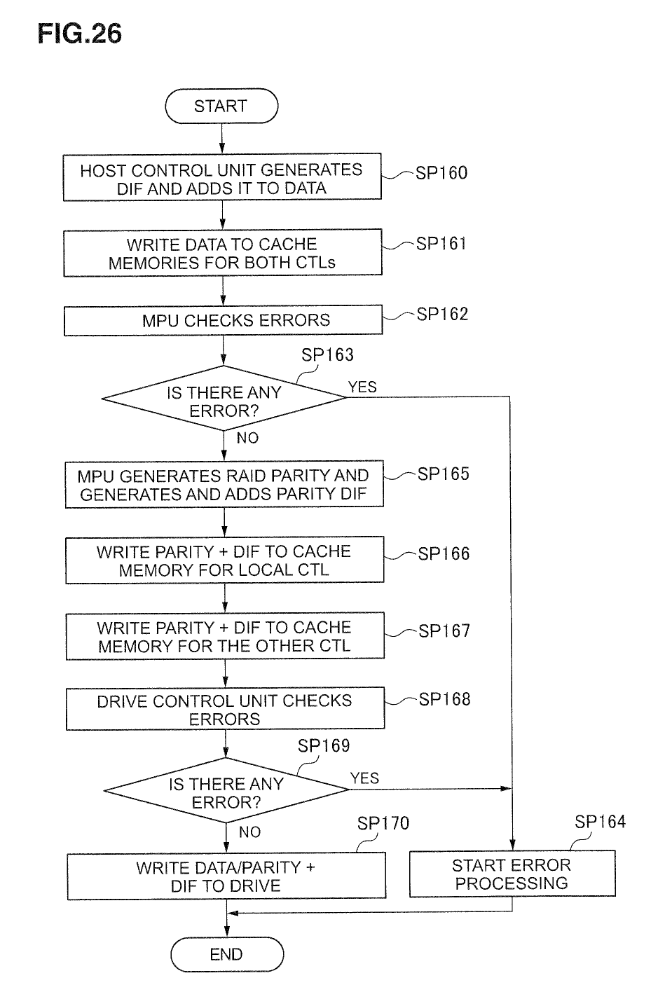

Due to the above-described difference in the configuration, a flow of write processing in the computer system 70 is also different from that in the storage apparatus 60 according to the fifth embodiment. FIG. 26 is a flowchart schematically illustrating a flow of write processing executed by a storage apparatus 71 according to the sixth embodiment.

Incidentally, FIG. 25 shows a flow of processing in the storage apparatus 71 when the controller 72A for system 0 in the storage apparatus 71 receives a write command and write data from the host server 3, and the same processing will be executed when the controller 72B for system 1 receives a write command and write data.

The flow of data indicated with arrows RA60 to RA64, arrow RB60, and arrow RB61 in FIG. 25 is the same as that indicated with arrows RA50 to RA54, arrow RB50, and arrow RB51 in FIG. 23. Processing executed in steps SP160 to 8P167 in FIG. 26 is completely the same as that executed in steps SP140 to SP147 in FIG. 24.

The difference between the sixth embodiment and the fifth embodiment is that while the processing for checking errors in the write data and the RAID parity is executed by the DMA unit 13A for the switch 9A in the storage apparatus 61 according to the fifth embodiment, such error check processing is executed by the drive control unit 33A for the storage apparatus 71 according to the sixth embodiment.

Specifically speaking, after the RAID parity for a group of data, which consists of the write data and its data error check code, and its parity error check code are stored in the cache memory 10B for system 1 in the storage apparatus 71 according to the sixth embodiment (arrow RB60 in FIG. 25 and SP167 in FIG. 26), the drive control unit 74A for system 0 reads the write data and its data error check code as well as the RAID parity thereof and its parity error check code from the cache memory 10A for system 0. Then, the drive control unit 74A for system 0 executes the processing for checking errors in the write data and RAID parity, using the data error check code and the parity error check code which have been read as described above (SP168 in FIG. 26).

If an error is detected as a result of the error check (SP169 in FIG. 26: YES), the MPU 8A for system 0 starts the aforementioned first error processing according to the program stored in the cache memory 10A for system 0 (SP164 in FIG. 26). Then, the storage apparatus 71 terminates this write processing.

On the other hand, if no error is detected as a result of the error check (SP169 in FIG. 26: NO), the drive control unit 74A for system 0 stores the write data and its data error check code as well as the RAID parity thereof and its parity error check code, which were read from the cache memory 10A for system 0 as described above, in the logical volume VOL designated by the write command at the address position designated by the write command (SP170 in FIG. 12). Then, the storage apparatus 71 terminates this write processing.

Incidentally, if the above-described write processing terminates normally, the write data and its data error check code as well as the RAID parity thereof and its parity error check code stored in the cache memory 10B for system 1 will be discarded later.

With the computer system 70 according to the sixth embodiment as in the case of the fifth embodiment, the processing for generating the error check code and the error check processing using the error check code are executed by the MPU 8A in the storage apparatus 71. As a result, it is possible to use a customized PCIe switch as the switch 73A, 73B and perform highly-reliable data transfer while keeping costs low.

Also, the error check processing is executed by the drive control unit 74A, 74B according to the sixth embodiment. As a result, data transfer between the cache memory 10A, 10B and the drive control unit 74A, 74B can be also secured and the reliability of data transfer can be further enhanced as compared to the storage apparatus 61 according to the fifth embodiment.

Furthermore, since the error check processing is executed by the drive control unit 74A, 74B according to the sixth embodiment as described above, it is possible to reduce processing load on the MPU 8A, 8B.

### (7) Seventh Embodiment

FIG. 27 in which elements corresponding to those in FIG. 23 are given the same reference numerals as those in FIG. 23 shows the configuration of a computer system 80 according to the seventh embodiment. The difference between this computer system 80 and the computer system 60 according to the fifth embodiment is that host control units 83A, 83B for a storage apparatus 81 do not have the function generating the error check code and the MPU 8A, 8B executes the processing for generating the error check code and the error check processing using the error check code according to a program stored in the cache memory 10A, 10B.

Due to the above-described difference in the configuration, a flow of write processing in the storage apparatus 81 for the computer system 80 according to the seventh embodiment is different from that in the storage apparatus 60 according to the fifth embodiment.

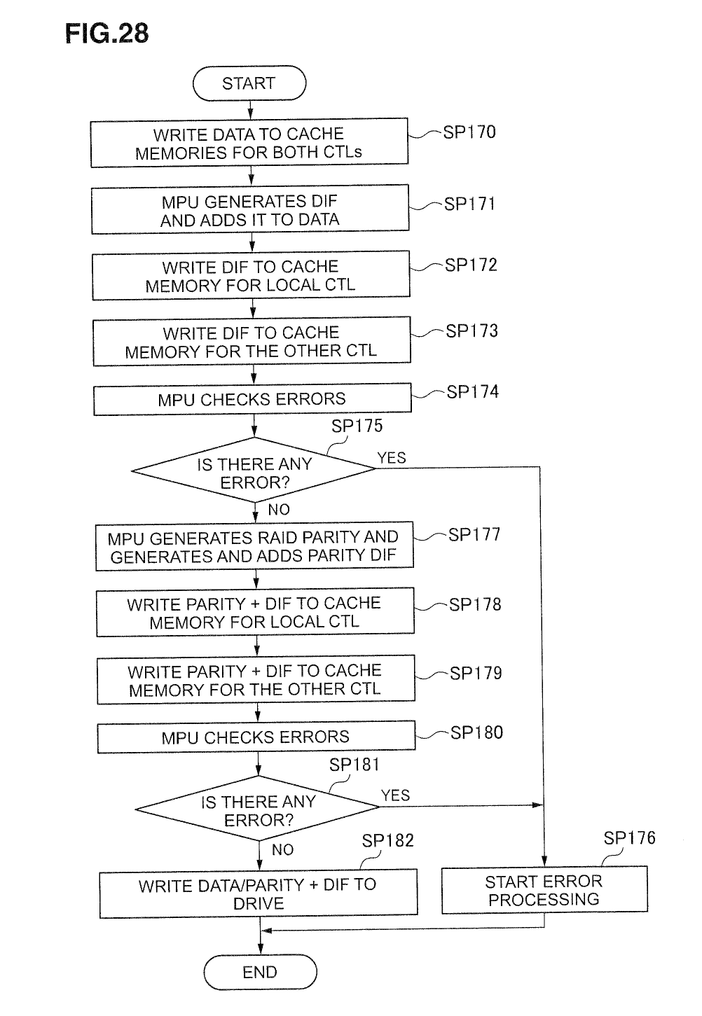

Incidentally, FIG. 27 shows a flow of data in the storage apparatus 81 when a controller 82A for system 0 in the storage apparatus 81 receives a write command and write data from the host server 3, and the same flow of data applies to the case where a controller 82B for system 1 receives a write command and write data. Furthermore, FIG. 28 is a flowchart schematically illustrating a flow of write processing executed by the storage apparatus 81 according to the seventh embodiment.

After the host control unit 83A for system 0 in the storage apparatus 81 receives a write command and write data from the host server 3 (arrow RA70 in FIG. 27), it sends the write data to the dual cast unit 12A for the switch 63A (arrow RA71 in FIG. 27).

The dual cast unit 12A stores the received write data in the cache memory 10A for system 0 and transfers it to the switch 63B for system 1, thereby having the write data stored also in the cache memory 10B for system 1 (arrow RA72 and arrow RB70 in FIG. 27 and SP170 in FIG. 28).

Subsequently, the MPU 8A reads the write data from the cache memory 10A according to a specified program 84 stored in the cache memory 10A for system 0 (arrow RA73 in FIG. 27) and generates a data error check code for this write data (SP171 in FIG. 28).

Furthermore, the MPU 8A stores the data error check code in the cache memory 10A for system 0 according to the program 84 (arrow RA74 in FIG. 27 and SP172 in FIG. 28); and the MPU 8A also reads the data error check code from the cache memory 10A for system 0 and sends it to the switch 63B for system 1, thereby having the data error check code stored also in the cache memory 10B for system 1 (arrow RB71 in FIG. 27and SP173 in FIG. 28).

Subsequently, the MPU 8A reads the write data and its data error check code from the cache memory 10A for system 0 according to the program 84 (arrow RA75 in FIG. 27) and executes the processing for checking errors in the write data using the data error check code (SP174 in FIG. 28).

If an error is detected as a result of the error check (SP175 in FIG. 28: YES), the MPU 8A for system 0 starts the aforementioned first error processing according to the program stored in the cache memory 10A for system 0 (SP176 in FIG. 28). Then, the storage apparatus 81 terminates this write processing.

On the other hand, if no error is detected as a result of the error check (SP175 in FIG. 28: NO), the MPU 8A generates RAID parity for a group of data which consists of the write data and its data error check code, and also generates a parity error check code for this RAID parity according to the program 84 (SP177 in FIG. 28).

Furthermore, the MPU 8A stores the RAID parity and its parity error check code in the cache memory 10A for system 0 according to the program 84 (arrow RA76 in FIG. 27 and SP178 in FIG. 28); and the MPU 8A also reads the RAID parity and its parity error check code from the cache memory 10A and sends them to the switch 63B for system 1, thereby having the RAID parity and its parity error check code stored also in the cache memory 10B for system 1 (arrow RB72 in FIG. 27 and SP179 in FIG. 28).

Subsequently, the MPU 8A reads the write data and its data error check code as well as the RAID parity and its parity error check code from the cache memory 10A for system 0 (arrow RA77 in FIG. 27) and executes the processing for checking errors in the write data and the RAID parity, using the data error check code and the parity error check code (SP180 in FIG. 28).

If an error is detected as a result of the error check (SP181 in FIG. 28: YES), the MPU 8A starts the aforementioned first error processing according to the program stored in the cache memory 10A for system 0 (SP176 in FIG. 28). Then, the storage apparatus 81 terminates this write processing.

On the other hand, if no error is detected as a result of the error check (SP181 in FIG. 28: NO), the MPU 8A reads the write data and its data error check code as well as the RAID parity thereof and its parity error check code from the cache memory 10A for system 0 according to the program 84 and sends them to the drive control unit 11A (arrow RA78 in FIG. 27).

Thus, the drive control unit 11A stores the write data and its data error check code as well as the RAID parity thereof and its parity error check code in the logical volume VOL designated by the write command at the address position designated by the write command (arrow RA79 in FIG. 27 and SP182 in FIG. 28). Then, the storage apparatus 81 terminates this write processing.

Incidentally, if the above-described write processing terminates normally, the write data and its data error check code as well as the RAID parity thereof and its parity error check code stored in the cache memory 10B for system 1 will be discarded later.

According to the seventh embodiment as in the case of the fifth embodiment, the processing for generating the error check code and the error check processing using the error check code are executed by the MPU 8A in the storage apparatus 81. As a result, it is possible to use a customized PCIe switch as the switch 63A, 63B and perform highly-reliable data transfer while keeping costs low.

Since all the processing for generating the error check code for, for example, write data and the error check processing using the error check code are executed by the MPU 8A, 8B according to the seventh embodiment, it is possible to reduce load on the host control units 83A, 83B and the drive control units 11A, 11B as compared to the case of the storage apparatus 4 according to the fifth embodiment and simplify the configurations of the host control units 83A, 83B and the drive control units 11A, 11B.

### (8) Eighth Embodiment

FIG. 29 in which elements corresponding to those in FIG. 27 are given the same reference numerals as those in FIG. 27 shows a computer system 90 according to the eighth embodiment. The difference between this computer system 90 and the computer system 80 according to the seventh embodiment is that a drive control unit 93A for a storage apparatus 91 has an error check function.

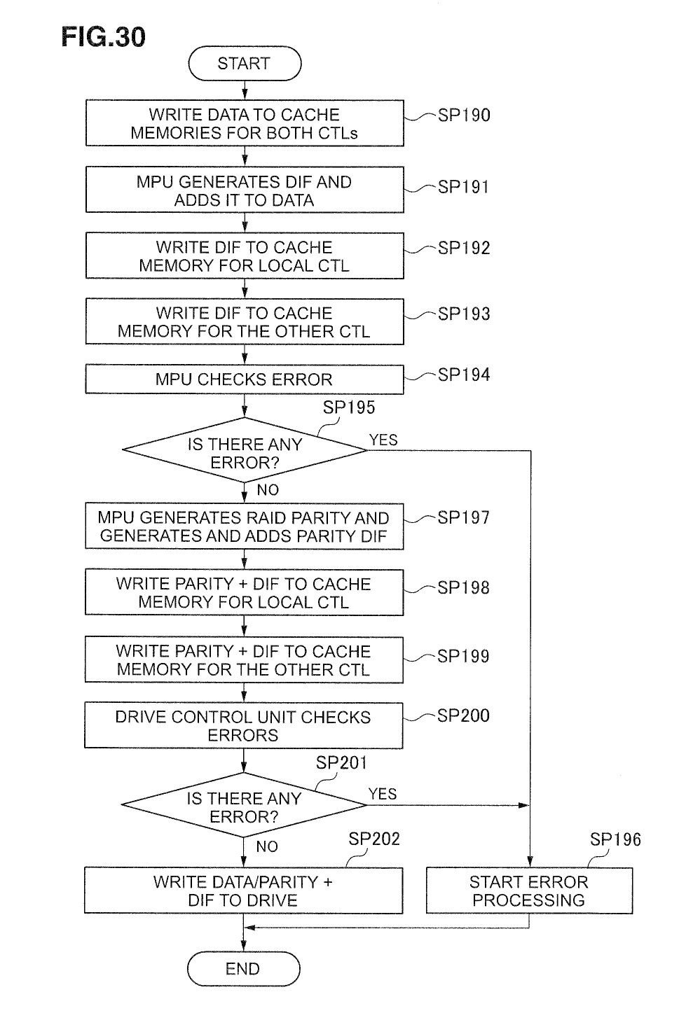

Due to the above-described difference in the configuration, a flow of write processing in a storage apparatus 91 for the computer system 90 according to the eighth embodiment is different from that in the storage apparatus 81) according to the seventh embodiment. FIG. 30 is a flowchart schematically illustrating a flow of write processing executed by the storage apparatus 91 according to the eighth embodiment.

Incidentally, FIG. 29 shows a flow of write processing in the storage apparatus 91 when a controller 92A for system 0 in the storage apparatus 91 receives a write command and write data from the host server 3, and the same processing will be executed when a controller 92B for system 1 receives a write command and write data.

The flow of data indicated with arrows RA80 to RA86 in FIG. 29 is the same as that indicated with arrows RA30 to RA37 and arrows RB30 to RB33 in FIG. 27. Also, processing executed in steps SP180 to 8P189 in FIG. 30 is the same as that executed in steps SP170 to SP179 in FIG. 28. The difference between the seventh embodiment and the eighth embodiment is that while the processing for checking errors in the write data and the RAID parity using the data error check code and the parity error check code is executed by the MPU 8A according to the seventh embodiment, such error check processing is executed by the drive control unit 93A according to the eighth embodiment.

Specifically speaking, after the MPU 8A for system 0 stores RAID parity for a group of data, which consists of the write data and its data error check code, and its parity error check code in the cache memory 10A for system 0 in the storage apparatus 91 according to the eighth embodiment (arrow RB82 in FIG. 29 and SP199 in FIG. 30), the drive control unit 93A for system 0 reads the write data and its data error check code as well as the RAID parity thereof and its parity error check code from the cache memory 10A for system 0 (arrow RA88 in FIG. 29).

Then, the drive control unit 93A for system 0 executes the processing for checking errors in the write data and the RAID parity, using the data error check code and the parity error check code (8P200 in FIG. 30).

If an error is detected as a result of the error check (SP201 in FIG. 30: YES), the MPU 8A for system 0 starts the aforementioned first error processing according to the program stored in the cache memory 10A for system 0 (SP196 in FIG. 30). Then, the storage apparatus 91 terminates this write processing.

On the other hand, if no error is detected as a result of the error check (SP201 in FIG. 30: NO), the drive control unit 93A stores the write data and its data error check code as well as the RAID parity thereof and its parity error check code, which were read from the cache memory 10A for system 0 as described above, in the logical volume VOL designated by the write command at the address position designated by the write command (arrow RA88 in FIGS. 29 and 8P202 in FIG. 30). Then, the storage apparatus 91 terminates this write processing.

Incidentally, if the above-described write processing terminates normally, the write data and its data error check code as well as the RAID parity thereof and its parity error check code stored in the cache memory 108 for system 1 will be discarded later.

According to the eighth embodiment as in the case of the fifth embodiment, the processing for generating the error check code and the error check processing using the error check code are executed by the MPU 8A in the storage apparatus 91. As a result, it is possible to use a customized PCIe switch as the switch 63A, 63B and perform highly-reliable data transfer while keeping costs low.

Since the error check processing is executed by the drive control unit 93A, 93B according to the eighth embodiment, data transfer between, for example, the switch 63A, 63B and the drive control unit 93A, 93B can be also secured and the reliability of data transfer can be enhanced as compared to the conventional art.

Furthermore, since the drive control unit 93A, 93B executes the error check processing as described above, it is possible to reduce load on the MPU 8A, 8B as compared to the storage apparatus 81 according to the seventh embodiment.

### INDUSTRIAL APPLICABILITY

The present invention relates to a storage apparatus and a data transfer method and can be used for a wide variety of storage apparatuses that transfer data in the storage apparatuses by adding an error check code to write data sent from a host server.

1. A storage apparatus for reading/writing data from/to a storage area provided by a storage device in response to a request from a host server, the storage apparatus comprising:
a host control unit for sending/receiving the data to/from the host server;
a drive control unit for sending/receiving the data to/from the storage device;
a cache memory for temporarily storing the data sent and received between the host control unit and the drive control unit;
a switch for switching between a transfer source and a transfer destination when transferring the data by selecting the transfer source and the transfer destination from among the host control unit, the cache memory, and the drive control unit; and
a controller for controlling the host control unit, the drive control unit, and the switch;
wherein processing for generating an error check code for the data and error check processing using the error check code are executed by the switch or are distributed among and executed by the host control unit, the drive control unit, the switch, and the controller.

2. The storage apparatus according to claim 1, characterized in that the switch is a PCIe (Peripheral Component Interconnect Express) switch.

3. The storage apparatus according to claim 1, characterized in that the processing for generating the error check code is executed by the host control unit, and
the error check processing using the error check code is executed by the switch.

4. The storage apparatus according to claim 1, characterized in that the processing for generating the error check code is executed by the host control unit, and
the error check processing using the error check code is executed by the switch and the drive control unit.

5. The storage apparatus according to claim 1, characterized in that the processing for generating the error check code is executed by the switch, and
the error check processing using the error check code is executed by the switch and the drive control unit.

6. The storage apparatus according to claim 1, characterized in that the processing for generating the error check code is executed by the host control unit, and
the error check processing using the error check code is executed by the controller.

7. The storage apparatus according to claim 1, characterized in that the processing for generating the error check code is executed by the controller, and
the error check processing using the error check code is executed by the drive control unit.

8. A method for transferring data in a storage apparatus for reading/writing data from/to a storage area provided by a storage device in response to a request from a host server, the storage apparatus including:
a host control unit for sending/receiving the data to/from the host server;
a drive control unit for sending/receiving the data to/from the storage device;
a cache memory for temporarily storing the data sent and received between the host control unit and the drive control unit;
a switch for switching between a transfer source and a transfer destination when transferring the data by selecting the transfer source and the transfer destination from among the host control unit, the cache memory, and the drive control unit; and
a controller for controlling the host control unit, the drive control unit, and the switch;
the data transfer method comprising:
a first step of receiving the data from the host; and
a second step of having the switch execute processing for generating an error check code for the data and error check processing using the error check code, or distributing the processing for generating the error check code error and the error check processing among the host control unit, the drive control unit, the switch, and the controller and having them execute the processing for generating the error check code error and the error check processing.

9. The data transfer method according to claim 8, characterized in that the switch is a PCIe (Peripheral Component Interconnect Express) switch.

10. The data transfer method according to claim 8, characterized in that in the second step, the processing for generating the error check code is executed by the host control unit, and
the error check processing using the error check code is executed by the switch.

11. The data transfer method according to claim 8, characterized in that in the second step, the processing for generating the error check code is executed by the host control unit, and
the error check processing using the error check code is executed by the switch and the drive control unit.

12. The data transfer method according to claim 8, characterized in that in the second step, the processing for generating the error check code is executed by the switch, and
the error check processing using the error check code is executed by the switch and the drive control unit.

13. The data transfer method according to claim 8, characterized in that in the second step, the processing for generating the error check code is executed by the host control unit, and
the error check processing using the error check code is executed by the controller.

14. The data transfer method according to claim 8, characterized in that in the second step, the processing for generating the error check code is executed by the controller, and
the error check processing using the error check code is executed by the drive control unit.
